(19) United States
(12) Patent Application Publication
(10) Pub. No.: US 2017/0031815 A1
(43) Pub. Date: Feb. 2, 2017

(54) Wand: Concurrent Boxing System For All Pointers With Or Without Garbage Collection

(71) Applicant: Pradeep Varma, Gurgaon (IN)

(72) Inventor: Pradeep Varma, Gurgaon (IN)

(21) Appl. No.: 14/928,790

(22) Filed: Oct. 30, 2015

(30) Foreign Application Priority Data
Jul. 29, 2015 (IN) 2312/DEL/2015

(51) Int. Cl. G06F 12/02; G06F 12/12; G06F 12/08

(52) U.S. Cl. CPC G06F 12/0253; G06F 12/0891; G06F 12/12; G06F 2212/69; G06F 2212/1044; G06F 2212/60

(57) ABSTRACT

Boxed pointers are disclosed, for all pointers, for safe and sequential or parallel use. Since a pointer box can be arbitrarily large, it supports any fat pointer encoding possible. The boxed pointers are managed out of the same heap or stack space as ordinary objects, providing scalability by a shared use of the entire program memory. The boxed pointers and objects are managed together by the same parallel, safe, memory management system including an optional precise, parallel garbage collector. To manage boxes independently of the garbage collector, explicit allocation and de-allocation means are provided including explicit killing of boxes using immediate or deferred frees. The entire system is constructed out of atomic registers as the sole shared memory primitive, avoiding all synchronization primitives and related expenses. Atomic pointer operations including pointer creation or deletion (malloc or free) are provided.

### FIELD OF THE INVENTION

This disclosure is about a boxing system for pointers in a program, safe manual and automatic memory management, and object access management including safety management.

### BACKGROUND OF THE INVENTION

Tagged types are common in programming languages, with a tag carrying type information for a value separately from the value itself. The tag may share space with the value or be separately stored. Sharing space is possible if the value space is smaller than the storage allocated for the value allowing unused storage to carry the tag. If a tag is allowed to be information rich, the space required by it forces additional storage to be used, which then has to be managed explicitly e.g. encoding a value as a fat value, which commonly compromises backward compatibility with legacy code, and atomic treatment.

Another treatment for the extra space required by a tag/value combination is to use a box tag within the normal value storage or separately, which signals that the storage carries a pointer to a box object, in which the total information is stored. In this scenario, box objects are managed by the language runtime as a part of the language implementation. In a tagged type implementation, when a value is shifted to a tagged value, it is required to be boxed if the tag expense cannot be borne by the value. Thus multiple types can end up being boxed, and a box tag in itself may not tell apriori what type of value is being contained in the box pointed by the storage.

Boxes are regarded as expensive and best avoided in efficient implementations. Hence boxing arithmetic types is not considered an advisable practice, with tagged type languages typically reducing the bits of an arithmetic type in order to represent them within a tagged type.

Lisp is a dynamically-typed language, with values carrying run-time tags to describe them. Hardware support, such as tagged architecture machines have been built for Lisp systems, e.g. the Symbolics 3600 model machine, in which the standard 32-bit word was expanded to 36-bit (or larger) word with extra bits supporting type tags. In software only Lisp implementations, with standard word sizes like 32-bits, the storage for types like arithmetic types is reduced in order to make space for the run-time tags. The textbook, Simon L. Peyton Jones, “The Implementation of Functional Programming Languages”, Prentice-Hall International Series in Computer Science, 1987, ISBN 0-13-453333-X, chapters 10 and 17, describes the variety of tags and boxes used in functional language implementations. The book points out that tags stored with a pointer may well describe the tags for the object pointed by the pointer. Thus a tagged pointer with several tag bits can describe the validity of its own tags as they apply to the pointed object. A minimum tag on a pointer may well describe the value as a pointer, as opposed to being say an unboxed arithmetic type. Tags specific to a pointer, as opposed to an object pointed to are not noted by the book. A tagged pointer at most summarizing the object's tags within the unboxed tagged pointer value is all that is covered. Incurring the expense of a boxed pointer, to cover rich tags or meta-data specific to a pointer value as opposed to the pointed object, is thus not noted. The expense of boxes in general and the need for a garbage collector of mark-scan, copying, or reference counting type to recycle boxes is discussed.

In object-oriented programming languages like Java and C#, primitive types may be boxed into object types. For example, int to Integer (Java), int to object (C#). By such boxing, a primitive type value is wrapped in an object created for it, usually an immutable object containing the value, and the reference of the object is propagated in the program. An object type may also be unboxed to obtain its primitive type value by the programmer usually, or by a compiler-inserted cast. Object allocation may be carried out in boxing a primitive type, with the garbage collector left the task of collecting unreferenced object types in the program. The decision, as to when to use a primitive type in a program or a boxed type is user decided, with compiler casts at best playing a supportive role. Boxing is expensive. The reason all primitive types are not boxed is because the choice is prohibitively expensive. Finally, note that pointers are not a Java type, nor is there any notion of boxing a pointer. In C# pointers are a primitive type, but no boxing or unboxing is supported over pointers.

C++11 has the notion of a pointer as a primitive type. It also has a notion of a smart pointer that can be derived from a primitive pointer value. A smart pointer however is restricted to pointing to an object that can be created with new and deleted with delete, so for instance it cannot be used to point to an object on the stack. Smart pointer management is tied to the object's storage management, the object being deleted when the last (shared_ptr) smart pointer to it is deleted. A smart pointer points to a manager object that in turn points to a (managed) object that without the smart pointer, would have been pointed to by a primitive pointer. There is supposed to be only one manager object for a managed object. All the primitive pointers in a program memory snapshot that would have been pointing to the managed object are now supposed to point to the manager object instead, as smart pointer versions of the primitive pointers. All these primitive pointers thus share one manager object as their shared box. In an alternative view, the single manager object does not represent a primitive pointer transformation, but rather it represents an object's transformation, the managed object's transformation, from itself to a pair comprised of the manager object and itself. This pair is what is now pointed to by outside pointers, with the manager doing an indirection. This alternate view is endorsed by a make_shared function template that lumps the pair into one object allocation for efficiency. Regardless, C++ provides for conversion of a primitive pointer value into a pointer to a shared manager object that serves as a box containing reference counts of incoming pointers. The deletion of the manager object occurs when the appropriate reference counts become zero. The purpose of smart pointers is memory management of managed objects, so when a shared_ptr reference count goes to 0, the managed object is also deleted by a destructor call. That only one manager object should exist for a managed object is not policed by C++. Thus double deletes are possible through two manager objects that a user is not supposed to construct. Also unchecked is the use of raw pointers by the user to the managed object, again with hazards like double deletes of a managed object. Further unpoliced is the reference counting mechanism of smart pointers, based as it is on the weak type system of C++, which can be beaten by an adversary using pointer casts among objects for example. Safety of smart pointers is not a guaranteed feature of C++. For unshared use, a unique_ptr smart pointer is also defined in C++11, but this entity has no reference counts for which a manager object or box needs to be allocated and hence does not generate a boxed pointer for itself.

The reference counted garbage collection (GC) of C++ smart pointers described above suffers from a cyclic structures problem. An unreferenced cycle of structures does not get deallocated by this GC because each structure has at least one live reference count coming from a pointer in the cycle. Since explicit managed object deletes are disallowed when smart pointers are used, the cyclic structures problem with shared_ptr smart pointers causes a memory leak in C++. The weak_ptr smart pointer is an extension of shared_ptr as a manual solution of this problem. This of course is not a policed solution, so user errors can result in memory leaks and memory mismanagement.

The reference counted garbage collection in C++ smart pointers is a global garbage collection solution. Thus in a multi-threaded program, the reference counts are contributed to by potentially all the threads of the program, requiring synchronization overhead in the managed object implementation, such as locks. This is an un-desirable overhead of the scheme.

Ruwase et al. in O. Ruwase and M. S. Lam, “A practical dynamic buffer overflow detector”, In Proceedings of the 11th Annual Network and Distributed System Security (NDSS) Symposium, pages 159-169, February 2004 present boxed pointer values, with a box being tied to a specific pointer value. As a pointer stored in a location X evolves (e.g. with pointer arithmetic), each changed value acquired by the location is represented by a changed box pointer stored in the location. This scheme does not identify a location containing a box pointer from another location containing a normal pointer, which limits the use of the scheme from perspectives such as memory management or tag-based dynamic typing. So the boxes in this scheme are limited and managed only for out-of-bounds pointers, somewhat expensively by tracking them in a dedicated hash table and deallocating the boxes for a referent object when the object is deallocated, at the expense of prematurely terminating the boxed pointer representation for a dangling out-of-bounds pointer (since automatic memory management cannot help a non-identified box pointer of this scheme).

Furthermore, Ruwase et al.'s scheme as presented is sequential and the creation of an out-of-bounds pointer involves testing membership of the pointer in an object's table, which in a concurrent setting can undergo a concurrent modifications such as an object deletion that also triggers the deletion of multiple out-of-bounds objects in the dedicated hash table. Besides looking up the object table, the dedicated hash table is also required to be looked up in a pointer value creation (say by pointer arithmetic), with the synchronization requirements of multiple modifications as above. If a new out-of-bounds box is allocated in pointer creation, then the dedicated hash table has to be updated with the new box. A pointer object deletion requires the tables to undergo multiple modifications as above. Thus out-of-bounds pointer creation in Ruwase et al. is not a lock-free/atomic operation.

U.S. Pat. No. 7,181,580 B2 overcomes the non-tagging support in Ruwase et al. by providing a back-pointer in a boxed pointer. Specifically, this scheme provides boxed pointers for memory-based pointers (not register-based ones), wherein the boxes are allocated in a map that falls in a reserved-range of a protected area accessed by a pointer controller that runs in privilege mode. Pointer updation, e.g. in a pointer assignment to a location X, checks whether a box is already pointed to by X, so that the box can be re-used for the assignment by re-filling the box. In a concurrent context, if multiple writers attempt to overwrite multiple fields in a pointer box thus (without explicit synchronization), the result may well be garbage contained in the resulting box pointed to by X. In another embodiment that is mentioned, of one map per process, X may point to a box from one process Y, which another process Z may update resulting in Z overwriting X with a pointer to a box it newly creates in Z's map area. In this overwrite, the handle to Y's initial box is lost. Next Y can do an update, creating a new box in Y's map area for the purpose and making the system lose track of Z's box. Next Z can repeat, creating its own new box and so on. This tango of interleaved pointer updates by two (or more) processes can result in a memory leak with the map areas filling up with new boxes with no recovery of the earlier ones. In summary, concurrency by separating maps suffers from a memory leak and concurrency with one shared map suffers from an inability to update multiple fields of a box atomically without using synchronization such as locks. In order for a box to support arbitrary pointer encodings, support for multiple fields within a box is essential. For example, needed control information fields in U.S. Pat. No. 7,181,580 B2 comprise spatial and temporal security information fields, without which the security offered by the system is incomplete (overflowed buffers and dangling pointers are not safeguarded against).

U.S. Pat. No. 7,181,580 B2 is substantially limited by an inability to handle register-allocated pointers. Its working is limited to memory-stored pointers that can be pointed back to from a box. A register cannot be back pointed to thus and efficient systems that rely on register-based parameter passing (comprising pointers) in function calls cannot be handled by U.S. Pat. No. 7,181,580 B2.

Finally, U.S. Pat. No. 7,181,580 as presented, specifically requires privileged mode operation for its pointer map and its working and is not suitable for regular applications that work in user mode.

Michael, in Michael, M. M., “Scalable Lock-Free Dynamic Memory Allocation”, in Proceedings of ACM SIGPLAN Conference on Programming Languages Design and Implementation (PLDI), 2004, pages 1-12 presents lock-free malloc( ) and free( ) using compare and swap as the underlying synchronization primitive. Compare and swap has the highest consensus number (∞) in contrast to the simplest construct of a shared memory machine which is an atomic register of consensus number 1, as shown on page 126, Herlihy, M.,“Wait-Free Synchronization”, ACM Transactions on Programming Languages and Systems, Volume 11, Number 1, January 1991, Pages 124-149. An atomic register is the minimal, basic building block of memory in a parallel, shared memory machine. It is desirable to build a highly concurrent system using atomic registers alone if possible. This basically, means using atomic reads and writes of scalar values to memory only, without locks or the test-and-set type synchronization primitives that implement locks. Avoiding explicit synchronization primitives also avoids any special cost incurred by them making the system more scalable and also portable (for the same reason).

Varma et al. (P. Varma, R. K. Shyamasundar, and H. J. Shah, “Backward-compatible constant-time exception-protected memory”, in Proceedings of the 7th joint meeting of the European software engineering conference and the ACM SIGSOFT symposium on The foundations of software engineering, ESEC/FSE '09, pages 71-80, New York, N.Y., USA, 2009, ACM), U.S. Pat. No. 8,156,385 B2, U.S. Pat. No. 8,347,061 B2, and Varma in US20130007073A1 provide atomic read and write operations over pointers in offering a memory management system and an object access management system for memory safety. Varma in Indian patent application number 2713/DEL/2012 (PCT/IB2013/056856, U.S. Ser. No. 14/422,628), expands this to atomic, synchronization-primitive-free dereferencing of a pointer also, while overcoming the limitations of prior art on atomic synchronization-primitive-free pointer operations described in detail in the patent application. The discussion is incorporated here by reference. Varma in 1013/DEL/2013 (PCT/IB2014/060291, U.S. Ser. No. 14/648,606) generalizes Varma in 2713/DEL/2012 (PCT/IB2013/056856, U.S. Ser. No. 14/422,628) to independent compilation. None of these systems however have atomic, synchronization-primitive-free pointer allocation/deallocation (viz. malloc( )/free( )), which is a deficiency in these systems.

Varma in Potentate, Indian patent application number 1753/DEL/2015, provides an obfuscating one-time-pad object pointer to denote a scalar part, wherein the pad object is a box encoding the value of the scalar part. The box is an ordinary program object, managed by the automatic memory management system (Varma in Indian patent application numbers 2713/DEL/2012 (PCT/IB2013/056856, U.S. Ser. No. 14/422,628), and 1013/DEL/2013 (PCT/IB2014/060291)) utilized in potentate. The system however suffers from inadequate synchronization-freedom (pointer creation/deletion comprising a box allocation/de-allocation uses locks) and compromises register allocation of pointers in its precise garbage collector. The precise garbage collector is necessary to recycle one-time pads.

As foregoing discussion on prior art shows, a general pointer boxing scheme does not exist in prior art that covers and provides a pointer-specific box to all pointers, viz. register allocated, stack allocated, heap allocated, tagged pointer value, un-tagged pointer value, inbounds pointer, out-of-bounds pointer, dangling pointer. There is a need for such a boxing scheme that can work safely across all programs across all program operations like pointer arithmetic and pointer casts, regardless of programmer competence or malice. The scheme needs to offer scalable storage management for boxes, including allocation de-allocation support and/or garbage collection. For concurrent use, the scheme should desirably work without synchronization primitive overhead, with as little conflict among parallel threads/processes as possible.

### SUMMARY OF THE INVENTION

Boxed pointers are disclosed, for all pointers, for safe and sequential or parallel use. No tag bits are added to any run-time value, thereby allowing all prior encodings for scalars, such as pointers, arithmetic scalars including standardized floating types, integer types to be usable as before in any language context, including the untagged C/C++, and tagged languages like Lisp and functional languages. Since a pointer box can be arbitrarily large, it supports any fat pointer encoding possible. The boxed pointers are managed out of the same heap or stack space that ordinary objects are comprised of, providing scalability by a shared use of the entire program memory. The boxed pointers and objects are managed together by the same parallel, safe, memory management system including an optional precise, parallel garbage collector. To manage boxes independently of the garbage collector, explicit allocation and de-allocation means are provided including explicit killing of boxes using immediate or deferred frees. The entire system is constructed out of atomic registers as the sole shared memory primitive, avoiding all synchronization primitives and related expenses. Atomic pointer operations including pointer creation or deletion (malloc or free) are provided.

A boxing system for any pointer in a program is disclosed. A pointer box accessed by one or more threads or processes can be recycled with no intervening garbage collection.

According to an embodiment, a new or unique box is used for each non-NULL pointer stored in a variable or location.

According to another embodiment, the unique box is obtained by a sequence of box-reusing, content overwrites of a new box used for the variable or location.

According to an embodiment, an object layout or type means for identifying a pointer containing variable or location is disclosed.

According to an embodiment, a means for identifying stack and register allocated pointers by re-using an allocated box collection is disclosed.

According to another embodiment, a precise garbage collector, using the identified stack and register pointers as a part of a root set is disclosed.

According to yet another embodiment, the precise garbage collector reclaims unfreed dead boxes, arising from racing pointer overwrites.

According to an embodiment, a box freeing means of explicitly killing a box for freeing using an immediate free or a deferred free is disclosed.

According to another embodiment, a means for reconciling concurrent kills of a box into one kill or free of the box is disclosed.

According to an embodiment, a means of allocating or de-allocating boxes in bulk for sequential or concurrent use is disclosed.

According to an embodiment, a means for creating or destroying a box branch-lessly is disclosed. The means comprises allocation, initialization, or de-allocation, or the use of multi-word reads and writes.

According to an embodiment, a source-to-source transformation means for complete implementation is disclosed. The means provides enhanced portability and integrated performance as a result.

According to an embodiment, the system consists of atomic registers or sequential registers as the sole shared memory or sequential memory primitive, ruling out any synchronization primitives.

A parallel, safe, memory management system is disclosed. The system comprises a heap partitioned among threads, boxed pointers, and deferred frees for providing safe manual memory management integrated with an optional precise garbage collector.

According to an embodiment, the system consists of atomic registers or sequential registers as the sole shared memory or sequential memory primitive, ruling out any synchronization primitives.

According to an embodiment, the garbage collector collects in parallel, with each thread collecting its own heap partition, clearing marking work sent to the thread on bounded buffers instantly using a deferred tag. This keeps all buffers readily available to work producers so that garbage collection progresses monotonically without deadlock, and the handling of all such work transpires in constant space by the reuse of object meta-data structures effectively.

According to another embodiment, completion consensus for garbage collecting works like marking transpires by baton passing among threads.

According to an embodiment, the system supports atomic pointer operations, comprising pointer creation or pointer deletion including any needed malloc or free.

According to an embodiment, the boxed pointers comprise pointer boxes that are unshared, or shared with reference counting, or shared with an implicit infinite count.

According to an embodiment, the system comprises a barrier prior to which accesses to all objects must complete. The barrier purpose comprises deferred freeing of objects or boxes, carrying out of garbage collection, modifying object layouts, creation of threads, or deletion of threads. The barrier itself is implementable using atomic registers only.

According to an embodiment, the system automatically translates a read or write operation on an object by encoding or decoding pointers transferred by the operation, according to the layout of the object.

According to another embodiment, the read or write operation uses the read-only property of a layout between epochs to be able to carry out reads and writes of scalars in an object atomically, despite the layout and the object occupying and being accessed from separate storages.

A parallel, work completion consensus system is disclosed. The system comprises a means for passing a baton round robin among threads till a complete round is made in which no fresh work is recorded by any thread in the baton.

According to an embodiment, the system consists of atomic registers or sequential registers as the sole shared memory or sequential memory primitive, ruling out any synchronization primitives.

A tagged union system is disclosed. The system comprises an object layout or type means for identifying a union containing variable or location. The system uses a boxed means for implementing the union by substituting the union with a pointer to a box wherein the box specifies the tag of the union and its contents. The contents thereby get a fully unconstrained storage, despite being placed in a union that occupies the same space as the contents.

A parallel garbage collection system is disclosed. The system collects in parallel, with each thread collecting its own heap partition, clearing marking work sent to the thread on bounded buffers instantly using a deferred tag. This keeps all buffers readily available to work producers so that garbage collection progresses monotonically without deadlock, with completion consensus for works like marking transpiring by baton passing among threads.

According to an embodiment, the system consists of atomic registers or sequential registers as the sole shared memory or sequential memory primitive, ruling out any synchronization primitives.

A parallel deferred freeing system is disclosed. The system comprises a barrier means using which all threads free cached objects in parallel and completion consensus is arrived at by baton passing.

According to an embodiment, the system frees pointer boxes in an object while freeing the object. The non-local boxes are collected in constant space by re-using object meta-data of the boxes effectively.

According to an embodiment, the system consists of atomic registers or sequential registers as the sole shared memory or sequential memory primitive, ruling out any synchronization primitives.

A boxing method for any pointer in a program is disclosed. A pointer box accessed by one or more threads or processes can be recycled with no intervening garbage collection.

A parallel, safe, memory management method is disclosed. The method provides safe manual memory management operations integrated with an optional precise garbage collector. The method comprises the steps of partitioning heap among threads, boxing pointers, and deferred freeing.

A parallel, work completion consensus method is disclosed. The method comprises a step for passing a baton round robin among threads till a complete round is made in which no fresh work is recorded by any thread in the baton.

A tagged union method is disclosed. The method comprises an object layout or type step for identifying a union containing variable or location. The method further comprises a boxing step for implementing the union by substituting the union with a pointer to a box wherein the box specifies the tag of the union and its contents. The contents thus get a fully unconstrained storage, despite being placed in a union that occupies the same space as the contents.

A parallel garbage collection method is disclosed. The method collects in parallel, with each thread collecting its own heap partition, clearing marking work sent to the thread on bounded buffers instantly using a deferred tag. This keeps all buffers readily available to work producers so that garbage collection progresses monotonically without deadlock, with completion consensus for works like marking transpiring by baton passing among threads.

A parallel deferred freeing method is disclosed. The method comprises a barrier step using which all threads free cached objects in parallel and completion consensus is arrived at by baton passing.

### BRIEF DESCRIPTION OF THE DRAWINGS

To further clarify the above and other advantages and features of the disclosure, a more particular description will be rendered by references to specific embodiments thereof, which are illustrated in the appended drawings. It is appreciated that the given drawings depict only some embodiments of the method, system, computer program and computer program product and are therefore not to be considered limiting of its scope. The embodiments will be described and explained with additional specificity and detail with the accompanying drawings in which:

FIG. 1 shows the barrier-spaced parallel computation model of Wand.

FIG. 2 shows the timing graph of a various-worker barrier.

FIG. 3 shows the timing graph of a parallel work conclusion consensus mechanism.

FIG. 4 shows the pad and object structures of Wand, in C pseudo-code.

FIG. 5 shows a subset of the architecture of Wand, centred on one thread.

FIG. 6 shows the timing graph of concurrent writers wherein a pad kill is missed.

FIG. 7 shows the implementation of tagged union by overloading the pad mechanism.

FIG. 8 shows the pointers stack of Wand.

FIG. 9 shows the live pointers, fixed-frame stack of Wand.

FIG. 10 shows bulk allocation and de-allocation of pads for a heap object.

FIG. 11 illustrates a block diagram of a system configured to implement the method in accordance with one aspect of the description.

FIG. 12 illustrates a block diagram of a system configured to implement the invention in accordance with a parallel, shared memory aspect of the description.

FIG. 13 illustrates a block diagram of a system configured to implement the invention in accordance with a parallel, distributed memory aspect of the description.

### DETAILED DESCRIPTION OF THE INVENTION

In the Summary of the Invention above and in the Detailed Description of the Invention, and the claims below, and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components, ingredients, steps, etc. are optionally present. For example, an article “comprising” (or “which comprises”) components A, B, and C can consist of (i.e. contain only) components A, B, and C, or can contain not only components A, B, and C but also one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof. Throughout the patent specification, a convention employed is that in the appended drawings, like numerals denote like components.

Reference throughout this specification to “an embodiment”, “another embodiment” or similar language means that a particular feature, structure, or characteristic described in connection with the embodiment is included in at least one embodiment of the present invention. Thus, appearances of the phrase “in an embodiment”, “in another embodiment” and similar language throughout this specification may, but do not necessarily, all refer to the same embodiment.

Disclosed herein are embodiments of a system, methods and algorithms for a boxing and safe, parallel, memory management system.

A boxing system for any pointer in a program is disclosed. A pointer box accessed by one or more threads or processes can be recycled with no intervening garbage collection.

A boxing method for any pointer in a program is disclosed. A pointer box accessed by one or more threads or processes can be recycled with no intervening garbage collection.

A parallel, safe, memory management system is disclosed. The system comprises a heap partitioned among threads, boxed pointers, and deferred frees for providing safe manual memory management integrated with an optional precise garbage collector.

A parallel, safe, memory management method is disclosed. The method provides safe manual memory management operations integrated with an optional precise garbage collector. The method comprises the steps of partitioning heap among threads, boxing pointers, and deferred freeing.

According to an embodiment, the system supports atomic pointer operations, comprising pointer creation or pointer deletion including any needed malloc or free.

According to an embodiment, the boxed pointers comprise pointer boxes that are unshared, or shared with reference counting, or shared with an implicit infinite count.

According to an embodiment, the system consists of atomic registers or sequential registers as the sole shared memory or sequential memory primitive, ruling out any synchronization primitives.

According to an embodiment, the system comprises a barrier prior to which accesses to all objects must complete. The barrier purpose comprises deferred freeing of objects or boxes, carrying out of garbage collection, modifying object layouts, creation of threads, or deletion of threads. The barrier itself is implementable using atomic registers only.

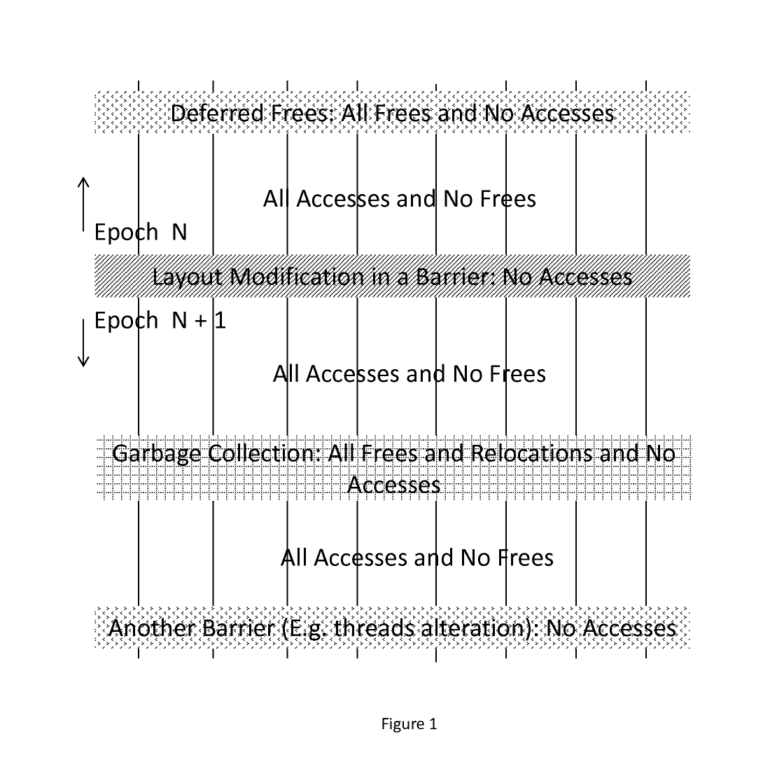

FIG. 1 provides a conceptual overview of Wand. FIG. 1 shows the barrier-spaced parallel computation model of Wand. Multiple threads of computation proceed in parallel, accessing data structures and variables for reads and writes, with the guarantee that a thread's referred memory addresses are not going to disappear on it regardless of the side-effects carried out by other threads. Memory recycling or re-structuring frees, and relocations occur inside barriers such as a deferred free barrier or a garbage collecting barrier. Data-structures are accessed by consulting layouts of objects, e.g. which location contains a pointer versus which contains a non-pointer data. A pointer is represented by an encoded representation, so the layout tells which location contains encoded data versus un-encoded data. To support dynamic changes to object layouts, the data within one or more objects may be re-structured by encoding decoded data or vice versa in the object's slot. The changed layout is then recorded as the new representation of the object. While these object(s) are being re-translated, no thread is allowed to access the objects, which is implemented by a barrier. Wand thus provides epochs of read-only layout computations, separated by layout-modifying barriers in the duration of a program.

Wand permits its entire computation to be carried out without the use of any synchronization primitives. Only atomic registers are assumed as the basic block of shared memory. Wand builds dedicated data structures (pc buffers, etc.), for this purpose. When the number of threads in a program is dynamic, then wand has to be able to restructure itself on the fly. This is carried out using a barrier again, as shown at the bottom of FIG. 1.

The barrier-spaced, atomic-registers based computation of Wand is designed to maximize efficiency by minimizing barrier and other costs. The disclosure next, provides the details, starting with a glossary, and a coverage of the most common subroutines and data structures of the system. These sections are followed by a detailed view of Wand, followed by Wand in the context of all machines (distributed, distributed/shared etc.), and claims.

### GLOSSARY

scalar: Following the C standard, a scalar type is an arithmetic or pointer type. A value of a scalar type may be referred to as a scalar.

object: Following the C standard, an object is an area of storage whose contained data may be interpreted as a value of some type.

atomic register: An atomic register is the basic storage of shared memory that may be accessed by multiple processors simultaneously.

Each processor gets to read only a whole value written to the register by some previous processor as opposed to some muddled mix of multiple writes. The order of parallel accesses to a register may be linearized in one sequential chain of accesses such that each processor appears to access the register according to this sequential order. A shared memory location supporting atomic reads and writes may be said to comprise an atomic register if one memory access alone comprises the atomic read or write (and not for instance a multitude or some synchronization primitive like a lock in addition). In this disclosure, since only heap-allocated objects undergo parallel access, atomic registers are needed exclusively for heap locations only, and not for instance, for addresses on the stack or for CPU registers, where simple sequential registers suffice.

deferred free: A deferred free, introduced in Varma12, is the delayed freeing of an object carried out within a barrier so that parallel read and write accesses to the object being freed are known to be complete prior to the deferred free. A parallel version of the deferred free of Varma12 is disclosed here, such that atomic registers or sequential registers only are required, eliminating the need for any synchronization primitives in the entire operation.

box: A box is a data-structure pointed from a location such that the box comprises type and/or other details of the value that is supposed to be contained in that location.

pad: Following the one-time pad object introduced by Varma in Potentate, Indian patent application number 1753/DEL/2015, a pad is a box in the novel boxed pointers disclosed herein. A pad is also overloaded for use as a box in a backward-compatible tagged union disclosed herein.

GC: Garbage collector or garbage collection. This disclosure presents a precise garbage collector in which all user-defined objects are movable. Pads are either movable, or their need for movement is eliminated by defining their optimized placement on a stack of pads apriori.

owning thread: A heap object's owning thread is the thread of the subheap that the object belongs to.

Subroutines and Data Structures

A parallel deferred freeing system is disclosed. The system comprises a barrier means using which all threads free cached objects in parallel and completion consensus is arrived at by baton passing.

According to an embodiment, the system frees pointer boxes in an object while freeing the object. The non-local boxes are collected in constant space by re-using object meta-data of the boxes effectively.

According to an embodiment, the system consists of atomic registers or sequential registers as the sole shared memory or sequential memory primitive, ruling out any synchronization primitives.

A parallel deferred freeing method is disclosed. The method comprises a barrier step using which all threads free cached objects in parallel and completion consensus is arrived at by baton passing.

Atomic Register Based Variable-Worker Barrier

The barrier described here uses only atomic registers for its implementation.

A barrier check comprises a thread polling a multiple-writer register (viz. a location or variable) for the state it is set to, which can be AVAILABLE, PENDING or a thread's flagged ID (fid). A flagged ID is a thread's ID (e.g. pid), augmented with flags including a one-bit flag that indicates a single-worker barrier if it is set to true (else it indicates a multiple-worker barrier). The checking thread enters the barrier if the state is a fid, else it ignores the register and moves on. All threads periodically carry out a barrier check as described above, by sampling the multiple writer register, to decide whether a barrier has to be entered into.

A barrier seeking thread on the other hand, first checks the multiple-writer register above if it is AVAILABLE before seeking a barrier as given below. If in the checking it finds the multiple-writer register set to an fid, it enters the barrier sought by that fid's barrier seeker, before returning to this checking/polling loop, if needed, for seeking a barrier.

Once the thread seeking a barrier samples the multiple-writer register as AVAILABLE, the thread sets two registers, which are the above multiple writer register, and one 1-writer waiting register, dedicated to the thread. In the multiple writer register, the thread writes its own fid, followed by writing the waiting register with a WAITING value and then polling the waiting registers for other threads.

For a thread entering a barrier, if a barrier entering decision is taken, then to enter the barrier, the thread writes its 1-writer waiting register, with a WAITING value. The thread then waits for all waiting registers to show a WAITING or READY-TO-WORK value before sampling the multiple-writer register again for knowing the winner of the barrier. After sampling the winner thus, the thread sets its WAITING register to a READY-TO-WORK value.

As mentioned above, a thread seeking a barrier polls the waiting registers, which it does till all of them have been set to WAITING or READY-TO-WORK. The waiting register have been set either because the threads are entering the barrier, or initiating a barrier. A seeking thread checks if its own fid is the value sampled from the multiple-writer register. If so, it assumes itself to be the winner and sets its waiting register to READY_TO_WORK. A non-winning seeker sets its waiting register to READY_TO_WORK and then proceeds like any barrier entering thread at this stage for the rest of the barrier. The winner thread on the other hand does its own work, as much as it can by itself, resets the multiple-writer register to PENDING after ensuring that all other threads' waiting registers show READY-TO-WORK, resets its own waiting register to FREE and then resets all the other waiting registers to FREE. Thereafter it resets the multiple-writer register to AVAILABLE and either moves on from the barrier, if it knows its work is complete, or it participates in the baton-passing work completion protocol, whereafter it is free to move on from the barrier.

When a thread enters a barrier, after it has set its waiting register to READY-TO-WORK, it checks whether the fid sampled for the winner has a single-worker flag set or not. If it does, then the barrier is recognized to be a single-worker barrier and the thread then seeks to do no work in this barrier, other than waiting. This the thread does by polling its waiting register, till it becomes FREE. Similarly, a non-winning racing thread that sought to initiate a barrier decides its course of action based on the fid it finds in the sampled winner after it has written READY-TO-WORK. The thread reads the fid's single-worker flag to find out whether it is supposed to do work or not. If the single-worker flag is set, then the thread simply waits for its waiting flag to become FREE. If a barrier-entering or non-winning-barrier-seeking thread finds that the single-worker flag is not set, then it recognizes that the barrier winner has sought a multiple-worker barrier and proceeds accordingly. The thread looks up a work flag in the fid then to identify the work that is supposed to be done and does it, including participating in a baton-passing work completion protocol, if any. Thereafter the thread returns to wait for its waiting register to become FREE (which it trivially finds to be so in case it is baton passing). A barrier entering thread then moves on from the barrier and a barrier seeking thread is then free to choose whether to race and initiate a barrier again.

In any barrier, the barrier winner always does its work. It alone works, then the barrier is single-worker, else it is a multiple-worker barrier.

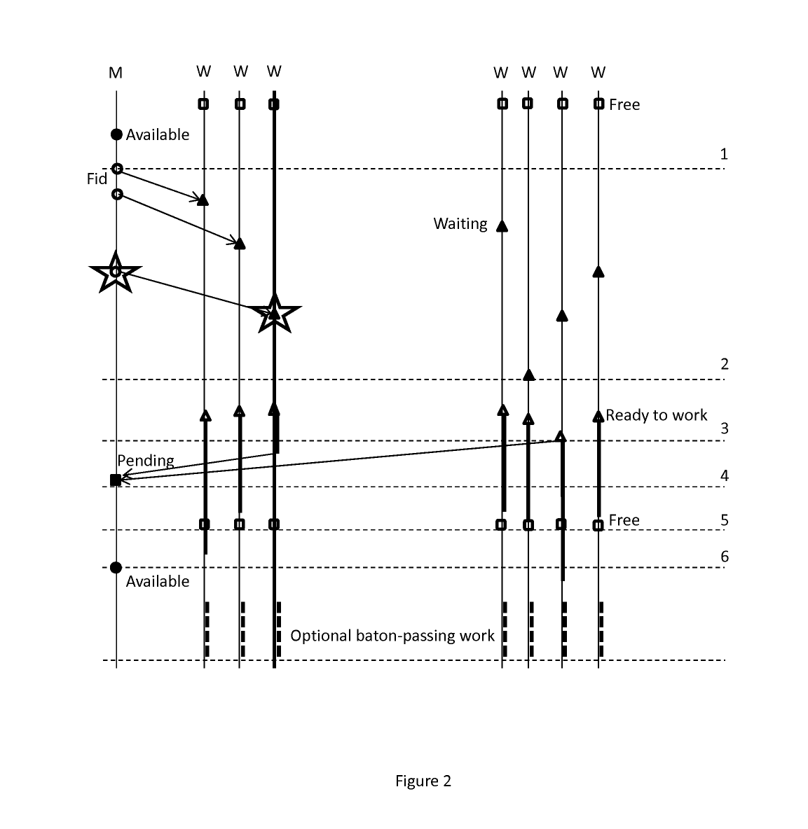

The working of the barrier is depicted in FIG. 2. A barrier is structured by atomic events on the global timeline, depicted by horizontal dotted lines in the figure, numbered from 1 to 6. Whether one or more atomic events may execute concurrently is discussed explicitly in each case. The vertical lines represent timelines of the multi-writer register (M) and the thread-specific waiting registers (W each). The global timeline may be viewed as a global clock running across the system, with specific atomic events partitioning the global time into different segments (separated by the horizontal lines).

Before a barrier is entered, M is in an available state. After event 6 (horizontal line 6), the barrier is complete and M is again in an available state. So barriers on the global timeline are separated from each other by stretches of M in the available state. From the time a barrier is begun (event 1), to the time it ends (event 6), M is in transitory states.

The waiting registers are grouped into two sets according to the threads they are affiliated with. The left set comprises threads seeking to win a barrier of which only one succeeds in the endeavour (shown as a thick line). The right set comprises threads entering the barrier to carry out their tasks. The threads in the left set that fail to win the barrier behave as a right set thread after the failure has been determined.

Each thread of the left set assigns to M a fid amongst which the winner is the last thread to do so. The barrier begins (event 1), when M is set to an fid from available. Threads from the right set enter the barrier (setting their Ws to waiting) only after event 1 has transpired. The first fid setting is a unique event partitioning the global timeline.

Multiple fid settings till the winning fid setting (depicted by a star) follow on M's timeline. The threads of the left and right sets set their Ws to waiting after reading or writing an fid. The winning fid setting event is succeeded by its W being set to waiting, also shown by a star. Either this event, or another W's assignment to waiting makes up event 2, which is the last thread to set its W to waiting. This event may physically occur concurrently in more than one thread, regardless, it partitions the global timeline with all the fid writings preceding this event.

All the threads then advance their Ws to READY-TO-WORK, with each such event succeeding event 2. Once the winning thread advances its W, it begins its barrier work, depicted by a thicker line segment for the period of the work it can do by itself. Event 3 marks the last advancement of W, which again may occur physically in multiple threads, but partitions the global timeline uniquely.

Whether the winner's solo work completes before event 3 or after is immaterial; the figure shows afterwards illustratively. Only after winner's solo work is over and every thread has advanced to READY-TO-WORK, does M transition to PENDING. Thus M's transition succeeds event 3 and this event uniquely comprises event 4.

Thereafter all the Ws are set to FREE, with the last such event making up event 5. These events are carried out sequentially by the winner and hence only one event comprises event 5.

In event 6, M is set to available again and this succeeds event 5. After this event, the system is ready to support another barrier repeating the above choreography again. Consider the case of no baton-passing completion work. In this case, the participant threads of the above barrier may or may not exit the barrier at event 6 in synchrony; some may have exited before, the winner exits at event 6, and others may exit afterwards, after completing their individual works. The thread works are shown in thick line segments with one thread working past event 6 illustratively in the figure. A later exiting thread may be viewed as simply a delayed thread, which is permitted in asynchronous systems, so the barrier structure, presented above, modularly repeats barriers again and again over a program run.

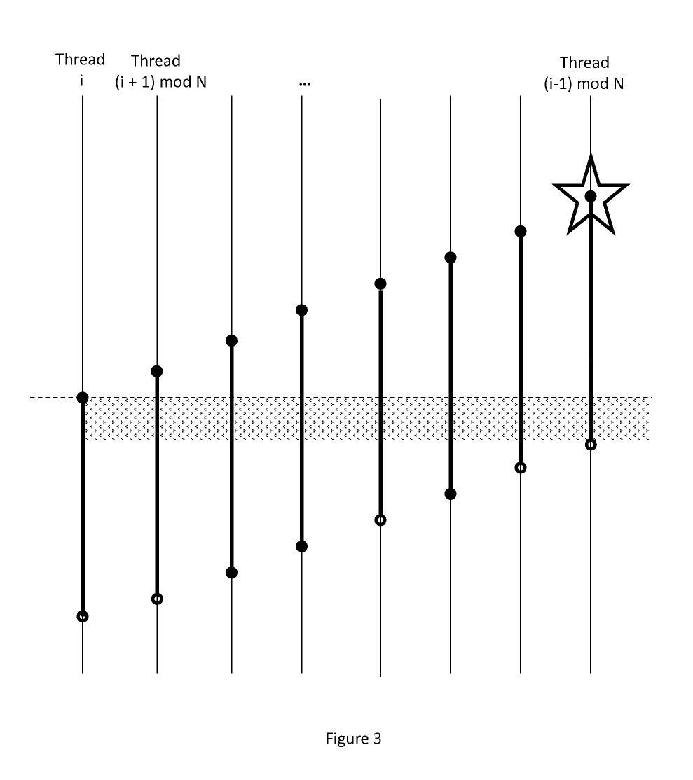

Consider now the case of baton-passing completion work. In this case the work requires the winner to re-enter group work, shown by a thick dashed line of baton-passing (and completion) work after event 6. The other threads of course find themselves engaged in baton-passing work then, after event 6, all shown as thick, dashed lines. This group work concludes together and is described in detail elsewhere (FIG. 3). It suffices to say that in case of baton-passing work, the threads work past event 6 and move on from the barrier only thereafter.

Highly Concurrent Deferred Free

This is a multi-worker barrier, with the work flag set to DEFERRED FREE work. When a thread starts working on this assignment, it inspects each object in its cache of objects to be deferred freed and either processes it (if it is an object that is local to the thread's subheap), or else sends it to another thread to free using the thread's pc buffer. A non-local object is sent to the thread it is local to. In carrying out its assignment, a thread thus works in parallel on its cache and incoming pc buffers. The objects on the incoming pc buffers are all local to this thread and therefore processed instantly. The objects on the cache are either processed instantly (local ones) or sent on an outgoing pc buffer. When a local object is processed, its contained pads are freed, among which the local ones happen instantly, while the non-local ones are put on their outgoing pc buffers. To ensure instant processing of a local object, a local pad is freed instantly, while a non-pad object is removed to a pending list (it is deleted from an allocated objects list), while its internal non-local pads are sent outwards; this ensures that each local object is processed in an instant (either freed or put on pending list). For the purpose of the discussion here, an instant comprises computation carried out within bounded time as opposed to an open-ended computation.

An outgoing pc buffer may get filled due to a slow consumer on the other end. In this case, the producer continues its parallel work wherever it can, and communicating at whatever pace it can on the slow pc buffer. Deferred free is concluded to be over using the work completion consensus mechanism discussed above.

An optional space reorganization during a deferred free barrier is carried out as follows. The setting of waiting registers to FREE by the winner after event 4 in FIG. 2 is delayed (as is the setting of the multi-writer register M to Available). All the threads enter into baton-passing completion work after their individual works. Except for the barrier winning thread, each other thread after the baton-passing deferred free work completion is noted, does the work of updating a global status variable for itself, in which the subheap status and any pending, unmet, allocation request details are posted. Thereafter, the thread notifies the winning thread of this update using its pc buffer. The winning thread after receiving all update notifications does a heap status analysis which also decides whether a GC is to be triggered by the winner after the deferred free barrier. In case a GC is to be triggered, no inter-subheap space transfers are carried out by the winner. Otherwise, next, before setting other threads' waiting registers to FREE, the winner sends to each thread an instruction on inter-subheap space transfers to be carried out. A thread after sending its update notification waits for either a FREE status on its waiting register, or an incoming transfer instruction. A transfer instruction, if received, comprises the thread's sending to other threads, the space it is asked to transfer. Alternatively, the thread could be the recipient of such space. Both the sender and the (all) receivers receive the transfer instruction and carry it out before sending a transfer done acknowledgement to the winner using a pc buffer. On one pc buffer, at most one memory space transfer is carried out. Combined with the instruction/acknowledgement traffic to the winner, at most two messages occupy a pc buffer. Thus by sizing a pc buffer to be larger than 2, this traffic can be entertained without blocking.

The winner after receiving acknowledgements from all transferring threads, proceeds to set the waiting registers of all threads to FREE (followed by setting the multi-writer register M to Available). Whether a thread is to do a simple DEFERRED FREE assignment or DEFERRED FREE WITH HEAP REORGANIZATION assignment is identified by the work flag in the fid set by the barrier winner. A space transfer may be carried out using the extended gap structures of Varma12 comprising blocks transferred from one subheap to another. The receiving subheap integrates a block upon receiving it as per Varma12.

The status summary of a subheap is written to its global variable by a single writer only, viz., the owning thread of the subheap. The summary may have multiple readers, which make and use best effort readings of the summary. The summary can be a single field, announcing the total space free with the subheap, or it can be multiple fields, giving a histogram of the free blocks with the subheap. The status can also detail the unmet or pending heap requests for the thread.

Another optional deferred free is a LOCALISED DEFERRED FREE. In this, each thread's assignment is to free only its local objects, leaving the non-local ones pending in its cache. Objects with non-local pads may be deferred to a later deferred free barrier. Thus no pc buffers are involved in this assignment. This assignment is identified by its work flag in the fid. This deferred free requires no baton-passing to determine work conclusion and completes by event 6 of FIG. 2.

Another optional deferred free is a LOCALISED DEFERRED FREE WITH FALLBACK. In this, each thread's assignment is to free only its local objects. At the end of this assignment, similar to space organization, the threads with non-local objects beyond a threshold communicate with the winner to enter a phase of pc buffer based non-local clearing. Again, this assignment is identified by a work flag in the fid. Again, in this fid, the FREE and Available settings are deferred, analogous to the other space re-organization deferred free.

Garbage Collection

If a thread seeking garbage collection barrier wins, then a garbage collection barrier transpires. Other threads that do not win, but were seeking garbage collection, cede their intentions at this point and do not try to garbage collect again after this barrier. Marking in garbage collection requires baton-passing to determine completion, with the threads continuing their individual asynchronous work if any after marking also as needed, before departing from the barrier.

The gc winner is the gc leader. Garbage collection, starting with marking proceeds on its own till completion. Thereafter, each gc-completing thread, if the gc barrier's work so specifies, enters into a heap reorganization phase similar to the LOCALISED DEFERRED FREE WITH FALLBACK option carried out with deferred frees (except that heap re-organization or gc here is not deferred to another following gc). Each thread updates its subheap status, informs the winner (viz. the gc leader) of this update, which after receiving all notifications informs each thread of the space transfers to be carried out. Transfers are carried out as described above in deferred frees with heap re-organization. Each thread, after seeing its waiting register set to FREE, moves on from the GC barrier.

Work Completion Consensus

A parallel, work completion consensus system is disclosed. The system comprises a means for passing a baton round robin among threads till a complete round is made in which no fresh work is recorded by any thread in the baton.

According to an embodiment, the system consists of atomic registers or sequential registers as the sole shared memory or sequential memory primitive, ruling out any synchronization primitives.

A parallel, work completion consensus method is disclosed. The method comprises a step for passing a baton round robin among threads till a complete round is made in which no fresh work is recorded by any thread in the baton.

The conclusion of parallel, shared work is a global decision, based on the local decisions of the worker threads. Each thread is assumed to be busy doing its own local work and handling further work sent to it on its incoming pc buffers. Examples of these works are deferred free works and marking works in garbage collection.

Thread 0, when its done with its own work (incoming pc buffers empty, all its own work done), sends a baton to thread 1, which similarly only passes the baton on after its done and so on. Thread 0 starts off the whole process deterministically, and any prior state of the global variable (from earlier barriers) that the baton is passed on is ignored by all threads. When the baton after visiting all threads returns to thread 0, thread 0 either passes it on (after concluding any fresh work and becoming completely done) as is to thread 1, or makes it a finishing baton. The baton is converted to finishing baton, if thread 0 hasn't seen any fresh work since it first sent the baton. If it has seen fresh work, then the baton is not converted. The finishing baton thereafter remains a finishing baton, till it encounters a thread that's seen fresh work since the last time it sent the baton and such a thread converts the baton back to a beginning baton. So the baton may undergo some number of such conversions till it stabilizes as a finishing baton. Once the baton has been a finishing baton for N times consecutively (assuming N total threads), then just after the last determination, before attempting a baton transfer to thread i, the thread (i−1) modulo N deems group work over and announces the fact by writing a work complete baton in the global baton variable for all threads to see. The baton passing is best done using one dedicated global variable. At any time, the writer of the variable is single and deterministic. Multiple readers read the variable awaiting their turn to own the baton and become the writer. While baton passing each thread continuously checks its incoming queues and work and clears it as soon as possible. So all during the deciding phase, all threads are working voraciously.

In the above, thread creation/deletion (discussed later) is accounted for straightforwardly by letting the first non-deleted thread play the role of thread 0. Modulo arithmetic (for next thread) is decided by viewing the non-deleted threads, round robin.

The proof of the baton-determined end-of-work consensus is given in FIG. 3. The figure shows the timeline of individual threads as they pass the baton around. Thread i is shown as the leftmost thread, with thread ids incrementing to the right using modulo arithmetic (modulo N). In its lower portion, the figure shows the baton being passed around in a non-stable context, with the baton, shown by a big dot in a thread timeline, shifting between an ordinary baton status (empty dot) or a finishing baton status (filled dot). In the upper portion of the figure, the baton is passed around from thread i to all successors as a finishing baton. Once the baton is recognized by thread (i−1) modulo N as a finishing baton, shown encircled in a star at the top right, group work is deemed to be over and this thread announces the result to the barrier winner (and others) via the global variable.

When the baton is determined as a finishing baton at the star, the following is known. For each thread, the time segment between an upper finishing baton the lower baton has seen no fresh work being done. Each of these time segments is shown by a bold line. Therefore for the shaded period of time across all threads, we have a situation that every thread is out of work and has no fresh work to do. Once this situation has arisen, group work is known to be over. However, the fact of this situation is only known when the finishing baton encircled in the star is determined. Now this thread immediately announces work over at this point. This result is optimal in not wasting any time after determination and allowing all threads to work fully in clearing work while the determination is being made.

pc Buffer

The buffer described here uses only atomic registers for its implementation.

A pc buffer is comprised of an array of fixed size N. A producer writes the slots of the array and a consumer reads the slots of the array. Each array slot comprises a 1-reader, 1-writer register. There is a producer_ptr 1-writer 2-reader atomic register and a consumer_ptr 1-writer 2-reader atomic register, containing the producer and consumer position in the buffer respectively.

Upon production of one value, the producer writes the producer_ptr slot and advances the producer_ptr register, modulo N. The produce_ptr register is written with the advanced value in one atomic write. The produce_ptr points at an empty slot that the producer can next produce to.

Before writing, the producer read samples the consumer_ptr value. If (producer_ptr+1) modulo N==consumer_ptr, then the producer must block waiting for the consumer to advance and free up a slot. This the producer carries out by polling the consumer pointer till it has advanced thus.

For consumption, the consumer reads the slot pointed by consumer_ptr. This the consumer can do if it is not pointed to by producer_ptr, which at any time points to the next empty slot to be written to. To consume, the consumer read samples the producer_ptr and if consumer_ptr==producer_ptr, desists from consuming till producer_ptr has advanced. The consumer polls the producer_ptr for this purpose as needed. When the consumer finds itself able to consume a slot, it does so and advances the consumer_ptr by 1, modulo N.

Initially, for an empty pc buffer, both producer_ptr and consumer_ptr are 0, indicating that slot 0 is the empty slot that will be written to next and that the buffer is empty with no data in it. Consumption occurs behind a producer_ptr position in the system, and production occurs just ahead of the producer_ptr position, well before a consumer_ptr position. Thus the array slots in pc buffer comprise 1-reader, 1-writer registers. Since production stops when (producer_ptr+1) modulo N==consumer_ptr, the array at most fills up with N−1 values at a time. Thus buffer capacity is N−1 at most, which for large N is quite efficient.

The pc buffer is based on Leslie Lamport's classical algorithm published in the literature in the 1970s.

Dynamic Thread Creation and Deletion

A barrier may be used to provide additional capability to the language as follows. Consider a language generalization, permitting threads to be generated dynamically, e.g. as in Linda. In this case, we presuppose a thread creation primitive that provides a new thread with a stack and an optional subheap. Now integration of such a thread with the rest of the system may be carried out in a barrier. In this, the barrier winner increments the total number of threads recognized by the system, adds global registers (e.g. waiting registers for the new thread) to say a containing array of all these registers, whose index space has increased with the addition of the new thread. The thread gets its subheap, either by demanding one from the presupposed primitive, or the winner re-cycles an existing subheap from a deleted thread as described below. The increase in the number of threads also adds a new pid to the space of pids. Every thread creates pc buffers to and from the new thread (or the barrier winner does this from say a global pool for thread creation).

For thread deletion, an array of thread statuses is kept, so that a deleted thread is marked in a barrier as deleted (by the barrier winner). The statuses inform everyone as to which registers/variables/pc buffers are live and to be polled in various protocols and which not. Prior to reclaiming pc buffers, all threads ensure that they've cleared the deferred frees on their incoming caches from the thread being deleted. Preferably the shutting down thread is participating in this barrier, and participates in a general deferred free before the barrier executes thread shutdown. Thereafter, everyone can reclaim the pc buffers to-and-from the thread being deleted, or the barrier winner can return the pc buffers to global pool for threads management. Next the barrier is completed and the thread shuts down if still live.

The subheap of a deleted thread may well contain objects and pads that are still live. So the subheap maintains its in-use status when the thread is deleted. The subheap may be assigned to a new thread in a thread creation operation later. In this case, in the thread creation barrier, the subheap's objects' and pads' pids are updated so that the new thread takes over and inherits the subheap's prior state as its own. When a garbage collection occurs, by user specification, un-assigned subheaps of deleted threads may have their live objects and pads shifted to other subheaps so that these subheaps can be returned by the garbage collection.

In the above, if the winner does all the work using a global pool, then the barrier is a single-worker barrier.

For convenience, the rest of the disclosure is generally presented as if no thread deletions or creations occur. This is to simplify presentation. Accounting for thread deletions and creations in an implementation would straightforwardly do polling based on status variables and implement protocols based on the “linked list” of active pids in the array of thread statuses, including identifying the head or first pid in the list and modulo arithmetic on the pids.

The Wand View

Consider the following publications/patents, hereafter referred to as Varmal: P. Varma, R. K. Shyamasundar, and H. J. Shah, “Backward-compatible constant-time exception-protected memory”, in Proceedings of the 7th joint meeting of the European software engineering conference and the ACM SIGSOFT symposium on The foundations of software engineering, ESEC/FSE '09, pages 71-80, New York, N.Y., USA, 2009, ACM; U.S. Pat. No. 8,156,385 B2; U.S. Pat. No. 8,347,061 B2; and US20130007073A1.

Consider the following patent applications, hereafter referred to as VarmaB: Indian patent application number 2713/DEL/2012 (PCT/IB2013/056856, U.S. Ser. No. 14/422,628); and 1013/DEL/2013 (PCT/IB2014/060291, Ser. No. 14/648,606).

Consider the following patent application, hereafter referred to as Varma12: Indian patent application number 2713/DEL/2012 (PCT/IB2013/056856, U.S. Ser. No. 14/422,628).

Consider the following patent application, hereafter referred to as Varma13: Indian patent application number 1013/DEL/2013 (PCT/IB2014/060291, Ser. No. 14/648,606).

Consider also the following patent application, hereafter referred to as Varma15: Indian patent application number 1753/DEL/2015.

Varmal and VarmaB radicalized the organization of memory safety systems by opting for a table-free approach wherein meta-data is kept locally, either with an object, or an atomic pointer instead of being accessed from tables. Stack-based objects with spatially-unsafe pointers were shifted to the heap to obtain a uniform, local meta-data treatment benefit for all objects. The size of an encoded pointer was contained to a scalar size (doubleword in general), making atomic treatment of the pointer possible, such as reads and writes.

This radical approach however suffers from bitfield-sized offsets and versions, which incur a time penalty in each use. The approach also suffers from a doubleword pointer size, which ideally should be singleword for backward compatibility. Backward compatibility means a prior program when ported to use the encoded pointers, should do so with minimum porting effort, which implies that the size of an un-encoded pointer and the size of an encoded pointer should be the same, allowing one pointer type to substitute for the other without upsetting any data-structure layouts.

It is desirable therefore to generalize the table-free and atomic pointers approach to work with standard fields alone, thus excluding bitfields, and to do so within a singleword-sized encoded pointer for the sake of backward compatibility.

To obtain all such benefit, this disclosure proposes a novel pointer representation, a boxed pointer, wherein a standard size pointer encodes another by routing the pointer through an interceptor object, a box, while doing its pointing job. The box can be arbitrarily sized, to allow as much detail about the pointer to be recorded, while containing the substituting size of an encoded pointer to a preferred one-word standard pointer size.

Besides obtaining backward compatibility, this novel design also obtains atomicity of its encoded pointers. Atomicity is highly desirable. As shown in Varma12, for atomicity, it is imperative that the pointer's value and its meta-data be up-datable and sample-able in one scalar read/write, else the separate items have to be sampled separately, resulting in non-atomic reads or writes (synchronization support and overhead is necessitated to sample the separate items together). The design here obtains atomicity because everything about the pointer, including value and meta-data is stored in its box, the encoding for which is a pointer to the box, and this encoding is sample-able or write-able as a standard one-word size scalar. The box is called a pad in the disclosure here, the name taken from the one-time pad object disclosed in our obfuscating memory manager called potentate, presented in Varma15. Ignoring obfuscating details, a simple pad is pointer box, containing an encoding for a pointer in its box. Since a box can be arbitrarily large, the encoding can contain full and many fields for the pointer instead of scrounging around with bitfields. The potentate pad is not concerned with atomicity or synchronization costs per se'. Atomicity is the subject of the present disclosure.

According to an embodiment, an object layout or type means for identifying a pointer containing variable or location is disclosed.

In the context of VarmaB, one prominent benefit of this design is in heap-shifted objects (from stack, or globals, or static section of the program) with repeated allocations, which benefit from an increased virtualization of larger, non-bitfield versions by avoiding GC intervention to recycle versions across allocations.

Heap-shifted objects comprise objects for which pointers exist that could access the object outside temporal or spatial bounds. For instance, a variable whose address is taken would have its object shifted to heap allocation (from stack, globals, or static section), so that access checks apply when the variable's pointer is used in defererences. Objects without unsafe access are left untouched as is, including pointer variables in the stack/global/static section. Such objects are characterised by their non-access by pointers themselves, e.g. a pointer variable x on the stack, or a pointer field of a structure x on the stack, viz. x.ptr, neither of which by themselves are pointer accessed by say *y or y->ptr, where y is a pointer. The type for safe objects defines their use definitively, as pointer casts do not exist that can weaken the static typing of such objects. This includes the precise identification of pointers within the safe objects.

With a pointer getting boxed and becoming a pointer to a potentate pad, a pointer read is simply an atomic read sampling of the singleword pointer to pad. A pointer write is an atomic singleword write of a pointer to a new pad. A different pad is needed in the general case for atomic writes, because a single write comprises the entirety of the atomic write and in general, the overwriting pointer can be entirely different than the earlier pointer necessitating a different, possibly new pad for it. If for efficiency, it is desired to re-use the existing pad, then in a parallel context, there can be multiple writers attempting the re-use and conflicting with each other in writing the fields of the pad. Such conflict can be resolved if the language/machine supports atomic writes of arbitrary-sized blocks. Otherwise, re-using thus does not work in general, atomically. In this disclosure, regardless of arbitrary-sized atomic writes (whether present, or not), we show that a new or unshared pad is most pertinent for atomic reads and writes as opposed to say a shared pad with reference counting.

With pads being created afresh potentially for pointer updates, it is crucial that the memory management of pads be as efficient and scalable as possible. In potentate, this is done by leveraging the full heap for pad management, treating pads as ordinary objects allocatable all over the heap and managing the same using the system garbage collector. The potentate design is very useful, but unfortunately is deficient because pad allocation is not lock-free. Among other difficulties, a pad allocation can trigger garbage collection, which is not lock-free either. Thus creating a new pad in a pointer update incurs one or more synchronization primitives. Thus an atomic write attempted via potentate necessarily requires synchronization overhead, a shortcoming that the present disclosure addresses.

A boxing system for any pointer in a program is disclosed. A pointer box accessed by one or more threads or processes can be recycled with no intervening garbage collection.

Furthermore, pad management is developed, to minimize GC overhead of the pad scheme. Pad killing and re-use opportunities are defined, made safe against concurrent references, which is a hard problem, typically requiring garbage collector intervention before a concurrently shared object is recycled. A garbage collector can certify when all (concurrent) references to an object are gone, enabling the object to be recycled. Designing our system here achieves the first solution of this hard problem in the literature, to the best of our knowledge, in recycling (pad) objects with concurrent references in a concurrent system automatically, without the intervention of a garbage collector. An example of object recycling in a concurrent system is the dissertation, Pradeep Varma, “Compile-Time Analyses and Run-Time Support for a Higher-Order, Distributed Data-Structures Based, Parallel Language”, Ph.D. Thesis, Yale University, USA, University Microfilms International, Ann Arbor, Mich., 1995, in which the first highly-concurrent design of a Linda system was offered. However, that solution too used a garbage collector to intervene in the concurrent object recycling.

It is to be noted that even supposing a garbage collector for intervening and solving pad reclamation is not an easy problem. Consider, for example, a reference-counting garbage collector. In such a system, each pad would carry a reference count of all pointers to the pad. When a pointer is deleted, the reference count would be automatically decremented, when another pointer added to point to the pad, the reference count incremented. Now consider a concurrent write on a pointer-keeping location. When a pointer to a pad is overwritten, who is responsible for decrementing the reference count in the pad? Since there are multiple writers, all of them cannot be allowed to decrement the count each. So the concurrent threads need to synchronize, e.g. using a lock, and then only one do the overwrite and as a part of the overwrite in a locked, critical section, decrement the count of the pointed pad. Note that heavy duty synchronization such as locks are necessary here. This is because both a count has to be written, and the pointer has to be written and both are in distinct, potentially far apart locations of memory. This cannot be done without synchronization such as locks. When a pointer to a pad is added, the onus of incrementing is clear—the thread adding the pointer does the incrementing. However, multiple threads may be incrementing and decrementing the pointer count simultaneously for different locations sharing the pad. So synchronization by say primitives like locks (test and set) or other primitives (e.g. read-modify-write) again is needed in carrying out the count update. Combined with the count decrement for an overwritten pointer, the count increment of the overwriting pointer has no option but to incur heavy synchronization overhead.

In the present disclosure, not only is garbage collector intervention avoided, the entire scheme, inclusive of an optional, virtualizable, general garbage collector, is developed out of atomic scalar reads and writes to memory or registers in the model of parallel shared memory machines. No synchronization primitives beyond atomic reads/writes are relied upon, such as test and set, compare and swap etc. The atomic, boxed pointers that are developed thus are standard pointers. If the standard pointer is not tagged, as in a C/C++ implementation environment, then the boxed pointer value carries no tag either. On the other hand, if a standard pointer carries a tag, e.g. as in Lisp/functional language, then the boxed pointer has its standard tag also, in pointing to a box. The box of course, may carry any meta-data specific to the pointer.

For run-time box management, as well as for dynamic typing, a pointer needs to be identified as such so that a box can be created or deleted upon a pointer update. To be language agnostic, and therefore applicable to all languages, all tagging/non-tagging contexts, our boxing system tracks a pointer separately from the box pointer by other means. So regardless of whether a standard pointer is tagged or not, our system knows where the pointers are in a running program. Ordinarily, if a pointer value's tag is separately kept, then discovering and reading a pointer cannot be done in one atomic act, such as sampling one tagged pointer value. It normally comprises two distinct reading samples, of the separate tag and pointer values, which then compromises atomic sampling without synchronization. Another of the novelties offered by our system is this separate tracking mechanism, that still enables atomic, synchronization-primitive-free sampling of a boxed pointer. This overcomes deficiencies a and b, suffered by other safety systems as described in Varma12.

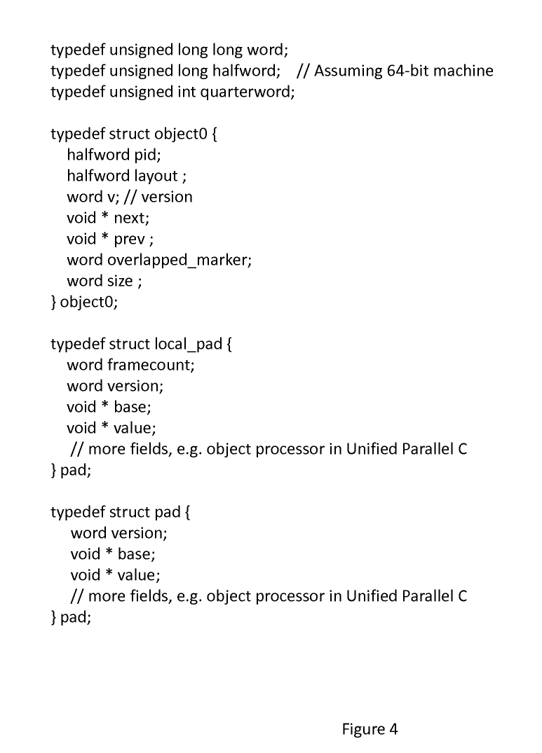

Given the discussion above, the object and pointer metadata of our table-free safety scheme is given in FIG. 4. Note how cleanly it generalizes the bitfields given in its counterpart in Varma12. The object0 structure represents the meta-data header of any object in the system including a pointer pad. In this meta-data, the overlapped_marker in the present system is more efficacious than Varma12 because the collector here is precise, eliminating any need for keeping objects on a quarantine status. So a quarantine bit does not need to be carved out of the overlapped_marker outside a GC phase. Like Varma12, the overlapped purpose of the marker is served during garbage collection, in less number of tag bits than Varma12 since the quarantine tag is gone. Since version analysis is obviated by the precise collection, no count storage is necessary in the overlapped_marker during the GC phase. The index field for layouts is a half word, which is more than enough to cover all layouts necessary, since as in Varma12, the layouts count a subset of types and not objects and thus are few in number. A layout identifies the location of a pointer precisely in an object.

Synchronization-Primitive-Free, Concurrent Memory Management

Like many garbage collected languages, we can assume a contiguous heap to be available with the system. It can also be divided into two partitions, with a copying collector using only one heap at a time and copying to the other. In the context of C, the memory available may be assumed to be a sequence of blocks obtained from the operating system through a program run. In order to retain generality of description, we present our system as the last option, with the other cases being a simple restrictions of the general case. The system thus comprises of a sequence of memory blocks that the system may increase or reduce during a program run in interaction with the operating system.

For a concurrent system comprising K threads, the sequence of memory blocks are partitioned into a heap partition per thread such that each partition is roughly equal. In getting this, existing memory blocks may have to be partitioned individually. This is generally not desirable, with subheap sizes being allowed some relaxation to permit rough equi-sizing, not necessarily exact.

Once the heap is available as subheaps, each subheap is assigned to a thread to be managed sequentially by it using a sequentially restricted version of the technique taught in Varma12, which makes it possible to avoid synchronization costs like locks, unlike Varma12. A subheap/thread does not interact with the OS in asking for additional memory or returning it. This is deferred to a garbage collection phase to be carried out on behalf of the system. If a thread is unable to meet an allocation request, it calls for a deferred free and/or garbage collection for creating the space.

The threads communicate with each other using producer consumer buffers (pc buffers) between the threads. The buffers are fixed, constant-space arrays, wherein the producer and consumer move round robin, the distance between the two never exceeding the size of the buffer or becoming negative, so that the producer stays ahead and produces to an empty slot while the consumer stays behind and consumes from a full slot. The producer is the sole writer of its position in the buffer that the consumer also reads, while the consumer is the sole writer of its position that the producer also reads. The producer consumer buffer is thus implemented using two-reader one-writer scalar atomic registers as the most powerful primitive. No further synchronization primitive is involved in the buffers. Details of a pc buffer are given in the subroutines section provided earlier.

A pc buffer is used by a thread in de-allocating a non-local object. The object pointer is communicated to its owning subheap thread to deallocate the object. A highly concurrent version of Varma12's deferred frees are implemented, as given in the subroutines section earlier, so an object to be de-allocated sits in a dedicated cache for the purpose till it can be offloaded to its owning heap. There is one cache per thread for the purpose (viz. the notion of a cache is decentralised). A deferred free may be triggered whenever any thread's cache is full by that thread seeking a barrier. Since freeing happens in a barrier, all threads at this point are busy emptying their own caches and incoming buffers, as well as offloading non-local objects, so the buffers are constantly emptied by consumers. So regardless of a pc-buffer being full at the time a thread tries to offload an object, the barriered de-allocation processing ensures that the offloading thread will eventually be able to make progress without deadlock. Specifically, the consuming thread will not be distracted by other computation into a deadlock situation. The barrier ensures that the consuming thread is dedicated to de-allocations alone and will eventually free up its buffer for the producer to offload.

A thread carries out an allocation request from its own subheap if it can. If it is out of space, it can initiate a deferred free barrier with heap space reorganization, to obtain more space to allocate from. For this, each allocation or object access request has to size out apriori the maximum space demand it will place on its subheap so that a decision to invoke deferred free ahead of time can be made. Thus when an allocation is carried out, it never fails due to the subheap being out of space. The winner thread in a deferred free barrier with heap space reorganization always decides whether to do the space reorganization or defer to a garbage collection.

Barriers based on atomic scalar read/writes are entered by the system disclosed herein by the periodic reading of a deciding multi-reader, multi-writer variable (see subroutines section). Barrier checking is carried out at candidate positions, such as object access, such that no two barrier tests by a thread are spaced indefinitely apart. There are two costs that the system must trade off. The cost of barrier checking, versus the cost of a barrier. A barrier check is simply a shared atomic register read, which is a minor cost. At its roots, it comprises the cache-coherence cost of maintaining the register fresh in each thread's memory. The cost of a barrier on the other hand is proportional to the interval between barrier checking, which is how long a thread may have to be waited for by a barrier. If the number of barriers in a program are few, e.g. for GCs alone, the allowed interval between barrier checks can be large, thereby reducing the minor barrier checking cost even further. On the other hand, if the number of barriers are large, e.g. for a program with lots of frees, the allowed interval between barrier checks should go down to curtail barrier overhead. Fortunately, a deferred free carries a notion of a minimum quantum of work, based on the size of cache, that tells how much a full cache must clear. This allows the sizing of interval overhead that a deferred free would be willing to entertain for itself. This in turn finalises the barrier checking overhead that the interval choice engenders.

Barriers are relied upon for a variety of deferred frees, threads reorganization, and garbage collection. Any of these activities can be forced to wait till the next barrier sampling takes place. Any thread with these activities is a barrier initiating thread. The progress of non barrier initiating threads till definite barrier sampling must not be blockable by other threads, or indefinitely extensible by itself. So such a thread must do barrier sampling in any loop or recursion it enters within say a bounded number of steps with the loop or recursion translated accordingly. This is straightforwardly done by inserting barrier sampling code during code translation step, explicitly, if the object access operations are not there already (Varma12).

In the design presented herein, there is no need for one deferred free seeker to continue seeking it in case it fails to be a barrier winner, unless the deferred free seeker wanted heap reorganization, and the winner did not do so. In this case, the seeker can well continue to seek a deferred free barrier after the winner's barrier. Other combinations of winner/seekers may be allowed by embodiments of the method taught here for continued barrier seeking after not winning one outright. Straightforward modifications, such as deciding garbage collection as a part of all deferred free barriers may also be carried out, in which case, the need for a non-winner to seek a barrier may go away.

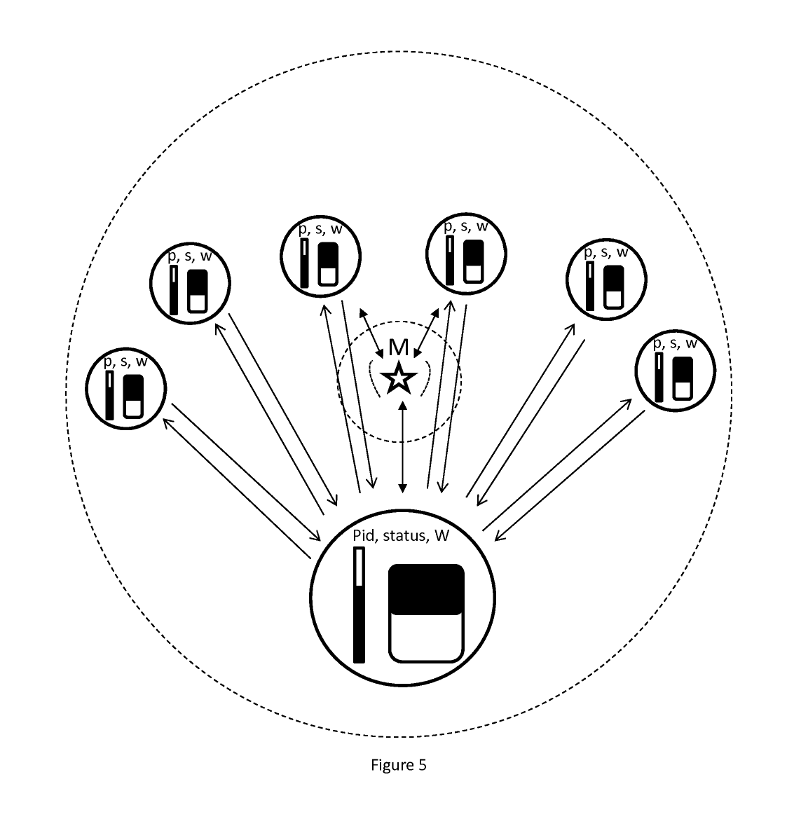

FIG. 5 summarizes a subset of the architecture of Wand, centred on one thread. It shows seven threads, in circles, each circle containing the thread's stack and subheap. The darkened memory in the tall thin stack and the rounded-rectangular subheap depiction represents memory in use. The figure is centred on the bottom thread. The bottom thread has a pc buffer to and from each other thread. State associated with each thread comprises its pid or identity, a status flag (whether the thread is active or deleted), and a waiting register W. The figure is illustrative, and hence not comprehensive, but contains several key elements of the Wand design. M, shown by a star, is the global multi-writer register used to choreograph barriers in the system. M is read and written by all threads. Barriers are depicted by concentric dashed circles emanating from M. The figure shows two barrier waves. One surrounds the system, depicting a completed barrier (the wave has run through). The second is a beginning barrier wave surrounding M. The duration between the two waves represents unfettered computation by the individual threads. An epoch of computation lies between the two barriers or more, depending on the work carried out by the barriers.

Synchronization-Primitive-Free, Concurrent Garbage Collection

According to another embodiment, a precise garbage collector, using the identified stack and register pointers as a part of a root set is disclosed.

According to an embodiment, the garbage collector collects in parallel, with each thread collecting its own heap partition, clearing marking work sent to the thread on bounded buffers instantly using a deferred tag. This keeps all buffers readily available to work producers so that garbage collection progresses monotonically without deadlock, and the handling of all such work transpires in constant space by the reuse of object meta-data structures effectively.

According to another embodiment, completion consensus for garbage collecting works like marking transpires by baton passing among threads.

A parallel garbage collection system is disclosed. The system collects in parallel, with each thread collecting its own heap partition, clearing marking work sent to the thread on bounded buffers instantly using a deferred tag. This keeps all buffers readily available to work producers so that garbage collection progresses monotonically without deadlock, with completion consensus for works like marking transpiring by baton passing among threads.

According to an embodiment, the system consists of atomic registers or sequential registers as the sole shared memory or sequential memory primitive, ruling out any synchronization primitives.

A parallel garbage collection method is disclosed. The method collects in parallel, with each thread collecting its own heap partition, clearing marking work sent to the thread on bounded buffers instantly using a deferred tag. This keeps all buffers readily available to work producers so that garbage collection progresses monotonically without deadlock, with completion consensus for works like marking transpiring by baton passing among threads.

Garbage collection with object moving capability is carried out using a novel, synchronization-primitive-free version of the technique taught in Varma12, as discussed here. Local variables containing pointers are tracked, free of space and space management cost, as explained below.

The space-free technique presented here leaves the stack and registers completely untouched. It supports any allocation choice for a pointer in the stack or registers by the compiler. By its hands off approach, it leaves the compiler completely unperturbed in its allocation decisions.

Register and stack allocated pointers are not identified by any object layout. They are identified by local variable types statically. To collect them as pointers dynamically, we first note that these pointers are all sequential, non-escaping (to other threads) pointers that are local to a thread. The pads for these pointers are managed explicitly, by explicit frees for instance, instead of deferred frees, as discussed in a later section. Again, as discussed later, these pads are separately implemented as suits their optimisation.

The procedure to collect the stack/register pointers for the GC root set therefore comprises walking through all live/allocated pads in a thread, and filtering the separately implemented local ones. These pointers comprise the root set for garbage collection. Added to this of course are the pointers in the global/static section, which are straightforwardly known from the types information and are implemented similar to the local ones. The pointers comprising the root set do not include pointers stored in objects moved to the heap from the stack or globals or static section.

Contrast this method with prior art, where in an attempt to collect pointers precisely, the locations of local-variable pointers are explicitly collected, thereby insisting to the compiler that these pointers have such locations with them. This insistance aborts any register allocation of such pointers, and hence makes the overall performance deteriorate. Also note that dynamically managed data structures are allocated on the stack or otherwise to contain such locations, carrying both time and space expense with them. None of these space and time costs are associated with our pad-inspecting algorithm. The existing investment in pads is re-used effectively in our work and also optimised for its specifics.

With stack and register pointers obtained by filtering live pads, the root set for garbage collection need not be obtained by scanning the stack and registers. It can be obtained straightforwardly by examining the live/allocated list of pads kept for local use of a thread (as opposed to those kept for concurrent use) or globals/static section. GC can run off this list. Furthermore, this approach allows a completely moving collection for all user-allocated objects, since it is only (some of) these pads themselves that may not be relocated. However, as the optimisation section later shows, these pads are so carefully optimised for their purpose, that no benefit exists in trying to move them from their optimised placement.

In garbage collection here, marking is carried out as given in Varma12, except for the use of the substitute root set described here. In marking, each pad pointer, representing an encoded boxed pointer, is identified either by consulting an object's layout or the root set pointers as described here. The root pointers' pads themselves are not marked, as they are known from their separate identity.

Upon encountering an encoded pointer in the heap, namely, a pad pointer, the marking relies on the following invariant obtained straightforwardly by the system—the pad pointed to is reached only by the marking thread via its subheap. This is because, even if the pad is non-local, it is the sole copy dedicated to the location of the marking thread's subheap (there is no sharing). The marking thread of course does not need to verify the invariant, it can simply use it. The pad is therefore marked by the marking thread, straightforwardly, followed by a procedure to mark the object pointed to by the data in the pad. As in Varma12, the procedure only marks the object, if it comprises a live object pointed by a live pointer, which is encoded in the pad. The object in this step may well be non-local; this is discovered by reading the pid field of the object, which is read-only in the marking phase of the garbage collector. If the object is local, the marking thread simply continues its marking of the object, as per Varma12. If not, the marking thread sends the pad pointer to the thread that owns the object for marking.

Each marking thread does two activities in parallel: (a) marking its local objects, as described above, and (b) polling its incoming pc buffers for marked pads whose objects it is supposed to mark. Note that by the time a heap pad arrives on the pc buffer for object marking, the pad has already been marked successfully since even though the (marking) event was concurrent, it transpired before the marking thread put the pad on the pc buffer. For the case when the pad did not have to be put on a pc buffer (i.e. the pointed object was local to the marking thread), this property still applies as the pad has been marked before that object is considered for marking through that pad.

For each incoming pad a marking thread finds, it marks the object pointed to immediately, as per Varma12, by simply opting for a deferred treatment of the object so that it can come back to the object later and mark it properly, at its leisure. The opting for a deferred treatment takes small, constant bounded time, so the marking thread processes each incoming pad instantly. The opting for a deferred treatment comprises marking an object with a deferred/excess tag, as provided by Varma12. The marking thread may of course not mark an object deferred, for example, if its tag shows that it is already marked to a final/definitive status. Regardless, the processing of each pad transpires in constant time, instantly. The marking thread thus proceeds in parallel, till it is completely done with marking its subheap and it finds that there is no incoming pad left on its incoming pc buffers. The instant processing of an object on a pc buffer above means the buffer is freed expeditiously for its producer to produce further, readily.

The conclusion of marking is a global decision, based on the local decisions of the marking threads. This is carried out as detailed in the work completion consensus technique given in the subroutines section.

After a thread determines that marking is over, it switches to a identifying the free/garbage objects, which happens sequentially, locally for each thread as per Varma12. Coalescing of the free objects into maximal free space (called extended gaps in Varma12) occurs also locally, as per Varma12.

Thereafter, each thread switches to live object relocation, as per Varma12. This step mirrors the marking step, except that as the objects are traversed, a determination is made as to which object is to be copied to a new location. The copy is made while traversing the objects, and then each moving object's body modified to contain a forwarding address. In a second marking-like step, the object graph is traversed again, updating the all pointers to point to moved objects as opposed to vacated objects with forwarding addresses.

In another coalescing step thereafter, the vacated objects are then combined with extended gaps to create maximal extended gaps. Version analysis as per Varma12 is not carried out. Since the collection is precise (other than pads, which have no version), all live versions (in objects) can be reset to 2 in GC, with dangling pointers reset to 1. This allows object versions to count upwards of 2 till the maximum unsigned integer store-able in a word, which is very large. Garbage collection hereafter completes.

A very effective variant of garbage collection that may be carried out is a copying collection. In this, each subheap is divided into two equal size partitions. In the marking phase, a marked object is also copied to the to-partition during marking and pointers updated to the moved object. An object is moved (leaving a forwarding address) when it is marked, with later visits to the object only updating the visiting pointer used. A non-local pad, when marked by a thread can also be moved to the thread's subheap, improving locality as a result. Indeed, when an object is copied, all pads for the object, using the object's layout can be copied alongside the object in the to-partition, further improving locality. Moving a pad thus leaves no forwarding address in an earlier pad. The location that points to an earlier pad in an unmoved object is used to discern the pertinent pad in the copied object, for updating the new pad.

A non-local object, since it is to be marked by a different thread, is sent to the other thread along with the visiting pointer's location so that the other thread can update the visiting pointer also, once the object is copy collected. Thus pc buffer traffic turns to pairs comprising object and visiting pointer, as opposed to simply the object in the prior GC scheme. Since a pad has exactly one source location that points to it, and one destination that it itself points to, the updating ownership transfers to the non-local thread cleanly. At any time, there is only one writer updating the (already created) pad for the visiting pointer. There is no reader reading the pad concurrently in this time, so the pad update need not be atomic.

Since an object may be visited by a dangling pointer before it is marked and moved, a dangling pointer may also move an object, without marking it. So an object move may occur prior to its marking. Now when marking occurs, it has to check if the object has already been moved and desist from moving thereafter. This method may end up copying a deleted, un-reused object or a dead object due to a dangling pointer, but this is must, if dangling pointers are to be preserved and copied as valid dangling pointers by the garbage collection. Of course, the garbage collection could reset the dangling pointers, e.g. to NULL, but that is the user's prerogative (e.g. a compiler flag specification).

Post garbage collection, within the same barrier, the subheaps among the threads can be adjusted, as per user specification. This for example may be done to increase the subheap of a thread with lesser free space left. The procedure is similar to the deferred free with heap reorganization option discussed in the subroutines section. Interaction with the operating system may also be carried out to obtain more memory, or return it, as per user specification in this time.

Finally, note that the entire system, including all garbage collectors is a completely source-to-source system. There is no need to go to assembler etc., for say accessing CPU registers. This is great for portability and/or scalability.

Explicit Pad Management without Reference Counting

According to an embodiment, a box freeing means of explicitly killing a box for freeing using an immediate free or a deferred free is disclosed.

According to an embodiment, the boxed pointers comprise pointer boxes that are unshared, or shared with reference counting, or shared with an implicit infinite count.

Following the philosophy of one-time-pad objects in Varma15, the simplest pad structure entertains no pad sharing. For each pointer variable to have a dedicated pad for itself, to be changed when the variable is updated e.g. by pointer arithmetic, requires that the space of pads in a running program be managed as a pool that largely manages by obtaining a free pad from a thread-local pool or returning a freed pad to a thread-local pool. Our disclosure makes this possible.

With unshared pads, no two threads share a pad either. Each may hold a pad with identical content, but each has a distinct pad regardless. When a pointer is transferred from one thread to another, a copy of the pad is transferred, with an open question being which subheap the copied pad ought to belong to. For the simple unshared pads considered in this section (no reference counting), we answer this question as the local subheap of the transferring thread. If the transferring thread is writing a pad to a non-local object, then the written pad does not have the pid (or locality) of the written object. If the transferring thread is copying a pad from somewhere (maybe nonlocal) to its own subheap object, then the pad written has the pid or locality of the written object. In a later section, on reference counting, we modify this subheap policy to use exclusively pads from the subheap of the object written to. This simplifies reference counting, at the expense of more complex pool management.

A pad without reference counts is read-only. It can be read-sampled by a parallel thread, that's supposed to save a copy for itself since its carrying out a transfer to itself. Now, the pad must not be de-allocated by its local thread before the complete copy occurs, and this in an asynchronous system cannot be guaranteed (normally). However, in our system, with deferred frees, we're guaranteed that any copying has already occurred by the time the deferred free is carried out in a barrier. So the thread deleting the pad can have it recycled then. This is true whether or not the pad carries reference counts (deletion occurs after 0 refcount). A 0 refcount means the pad is already off any local data structure, and at most is being copied asynchronously. And that any such copy has already finished by the time of the deferred free.

Pad allocation occurs when a pointer is copied from one local variable or location to another in the source code. There are only two options—a stack or register allocated local variable or aggregate (e.g. a struct), both of which we refer to as a variable, or a heap-allocated location, comprising a location in a heap-allocated object, that we refer to here as a location. Besides copying, a destination variable or location may acquire a different pointer value, based on intervening computation, such as pointer arithmetic. Regardless, at any time, the mapping from a pointer-containing variable/location to a pad is one-to-one. When a pointer-containing variable/location is initialized or updated, a pointer to a new pad is assigned to the variable/location. Any pointer to another pad, present in the variable/location from before is killed. Pad allocation is carried out when a new pad is obtained, and pad deallocation is carried out when a pointer is killed. Each creation/killing point is explicit in the source code of the program. The point can be intercepted by the compiler and code inserted to allocate/deallocate pad and populate it as needed.

FIG. 4 shows two pad structures, a local_pad, and a pad. A local pad is used exclusively for variables. A local pad contains a framecount field additionally to the information contained in a pad. As discussed later, the framecount is used to handle long jumps or exceptions in code. The framecount mechanism is one alternative presented here; stack unwinding for a long jump/exception may otherwise be carried out as in prior art, freeing pads pointed from the stack along the way, alternatively, in which case, both variables and locations can rely exclusively on pads and not local_pads. In this disclosure, we present the local_pads mechanism comprehensively.

For an object, a pointer-containing location is identified by a layout. For a variable, its pointer content if any is identified by its type. Since a variable is always identifiable in source code, the pads written to it or read from it are always identifiable as local_pads. Thus writing a pad to a variable or reading one is always carried out as a local_pad. If a variable's pointer is copied to a location, the local_pad is copied into a pad (ignoring framecount), so that the location only deals with pads in its reads and writes. When a locations' pad is copied to a variable, a framecount field is added, whose value is obtained from a local stack frame variable that tracks the present framecount in each procedure instantiation. In the rest of this discussion, we refer to pad copying, implying standard conversions to local_pad or pad depending on whether a variable is written to or a location.

Initialization and updates associated with a variable are all thread local. The variable's lifetime is explicit in source code, e.g. it is contained within the procedure instantiation or the innermost containing lexical scope. So when a variable goes out of scope, its contained pointer is killed. When a pointer variable is instantiated, viz. its defining scope is entered, it may be un-initialized. So long as the pointer is not read prior to a first assignment that effectively initializes it, the pointer variable may be left un-initialized as such for efficiency considerations. It need not be initialized by say a NULL pointer, as for example is done for a location when a heap object is allocated. If a pointer variable can be read along any path from its creation before assignment (determined straightforwardly, intraprocedurally), then the compiler, has two options. Either flag a compile-time error, which is preferred, and demand the user to fix this, or to insert NULL pointer initialization code for the variable explicitly. Regardless, all variables may be assumed to be initialized thereafter.

Since a variable is thread local, all pad allocations/de-allocations for it are thread local. Since no concurrent access to these pointer or pads can occur, the pads allocation/de-allocations are all sequentially ordered within the thread and a de-allocated pad can be freed immediately upon killing. These pads do not escape the thread and hence comprise what are called sequential, non-escaping pads.

When a variable's value is copied to a location, a pad copy is made using the subheap of the writing thread.

According to yet another embodiment, the precise garbage collector reclaims unfreed dead boxes, arising from racing pointer overwrites.

According to another embodiment, a means for reconciling concurrent kills of a box into one kill or free of the box is disclosed.

According to an embodiment, the boxed pointers comprise pointer boxes that are unshared, or shared with reference counting, or shared with an implicit infinite count.

When a location's pointer is killed by an update, two steps are carried out: the location is read and its pointer saved for de-allocation; the location is written with a pointer to a new pad. Due to concurrency, the location reading may be stale, regardless, the reading comprises a pad that has to be killed. Again, due to concurrency, more than one thread may seek the killing of this pad. The killing is carried out by a deferred free of the pad. At the time of a deferred free is carried out, no thread is accessing any location and all killings for this pad have been reported. The deferred free for this pad is carried out by the thread to which the pad is local and it combines the multiple killings into one de-allocation of the pad as follows: the first free action on the pad that is encountered succeeds and later free actions do not, since the pad is no longer on the live/allocated queue.

The reason the above method works is because for a pad to be saved for a killing, it has to be read as such between its creating assignment to the containing location and read thus before an update. Since a pad is never shared with another variable/location, the lifetime of the pad is defined within the location as above. So long as the system maintains an invariant that a location pad is recycled by a deferred free alone, before any other lifetime arises for this pad, the deferred free will transpire accounting for reclamation of the pad, along with all of the one or more killings carried out for it.

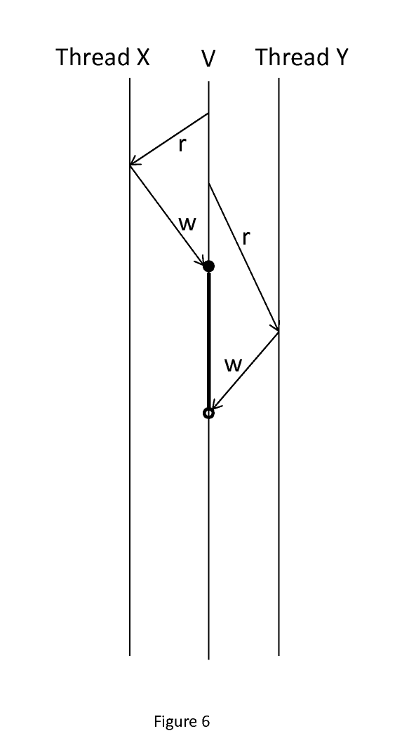

The method above works with very high probability, but it can miss pads as illustrated in FIG. 6, which then have to be collected by GC. The missed pads would be a rare occurrence in a running program, comprising racing writes to the same location within a narrow time window. In a program run without GC, the missed pads would comprise a memory leak, but it may be ignorable in most contexts.

FIG. 6 shows two threads racing to write a pointer variable V with a pointer. Thread X reads V first followed by thread Y reading it. Then thread X writes V, followed by thread Y writing it. Now both threads report kills for V's pad before X overwrote it. Thread X's pad is pointed by V for the time segment in bold, after which, thread Y's pad is pointed by V. Thread X's pad thus dies, but, not reported as a kill. This missed pad comprises a memory leak, fixed only by the system garbage collector. Such a simultaneous scenario is possible, but unlikely, since it is a highly coordinated, multi-party event.

When a pointer in a location is killed, the saved pad is stored in the deferred free cache of the killing thread to be freed in a deferred free barrier later.

When a heap object is allocated, its pointer slots, according to its layout are initialized with the NULL pointer. In a shared option, the NULL pointer is a shared pad, with no reference counts, that is never deleted. Thus NULL is equivalently a shared pad with an infinite reference count. The count of course is not kept, increment and decrements on the count being immaterial and therefore not carried out. Kill requests on the NULL pointer are simply ignored. When a heap object is freed, the action is carried out by a deferred free in a deferred free barrier. Pointers in the object are all located using the object's layout, and killed. When the object is being freed in the barrier, some of the pointers within it are freed by the freeing thread (the local pads) instantly, while others have to be sent to their respective threads for freeing. To do this, the size field of a pad's object0 may be temporarily used as a linking field as follows. The size field of a pad is normally unused. In this field, a pointer to a next pad can be written. For a given thread pid, all pads to be sent to it for deferred freeing are collected into a linked list of pads using their size fields. The list expands each time an object is freed with surviving pads to add to this list. The list contracts as space is found on the pc buffer to send off the pads to their destination. Before a pad is put on a pc buffer from a linked list, the normal size setting of its size field can be restored. When pad sizes are manipulated thus, the manipulation occurs sequentially by the freeing thread and hence is safe.

It is to be noted that each pad found surviving in an object being deferred freed is known to not have had an (update) killing carried out for it, else it would have been replaced by the time deferred free occurred and hence not found surviving as above. So for surviving pads, killed as above, only one killing per pad transpires, which is handled easily by the system.

A deferred free only acts on cached or surviving pads, which are all location pads. It does not visit a sequential non escapee pad ever.

For handling long jumps/exceptions in sequential non escapees (i.e. local_pads), a stack frame count of the pad creating stack frame is stored in the framecount field. Each procedure is instrumented to have a local variable tracking its position among procedure frames on the stack (viz. a stack frame count). When a procedure is called, its local variable (on the stack) acquires the calling procedure's frame count, incremented by one. When a procedure returns, its local variable is popped along with the rest of the stack frame. A global variable may be used to assist transfer of a stack frame count from a calling procedure to a called procedure (by tracking the current stack top count).

After a long jump/exception, at the exception catcher or return point, the local stack frame variable is consulted to determine what all frames have been popped (viz. the higher counts). Next, the allocated pads are visited and all those local pads with a larger frame count are killed. From a destination of long jump/exception to the containing procedure's exit, it has to be ensured that any pad with the procedure's frame count also has a kill for it by the time the exit occurs (viz. that kills located elsewhere for the normal path should not end up being bypassed by a long jump/exception path). This is straightforwardly instrumented intra-procedurally by the compiler (conservatively, all pads with the procedure's framecount can be looked up and killed, but this would incur a search cost that the intraprocedural analysis would easily eliminate).

Pad management for any thread subheap would be straightforwardly carried out as in Varma12. A pad is just another heap object with an object0 header (FIG. 4). Pad allocation and de-allocation would use dedicated procedures, since versions are ignored. No access checks are carried out as per Varma12 in accessing a pad, since all uses of pads are system generated and safe. Reuse of pads for non-pad heap objects of the same size is possible, except that version information tracked by ordinary objects, to name lifetimes, is not tracked in pads. For precisely this reason, when a pad is re-used as an object, if the pad had earlier seen use as an object, the object version of that time survives when it returns as an object. Thus version information, used by objects, survives their intervening use as pads also. A dangling pointer for an object, when it attempts to access a pad incarnation of the object would fail the normal temporal test, given that the pad has the latest object version stored in it. Thus, in summary, comprehensive re-use among pads and objects is possible without the intervention of a garbage collector in the present disclosure.

Heap Object Read and Writes

According to an embodiment, a new or unique box is used for each non-NULL pointer stored in a variable or location.

According to another embodiment, the unique box is obtained by a sequence of box-reusing, content overwrites of a new box used for the variable or location.

According to an embodiment, the system automatically translates a read or write operation on an object by encoding or decoding pointers transferred by the operation, according to the layout of the object.

According to another embodiment, the read or write operation uses the read-only property of a layout between epochs to be able to carry out reads and writes of scalars in an object atomically, despite the layout and the object occupying and being accessed from separate storages.

Before a read or write operation is carried out, the number of new pads to be constructed in the operation is known, based on the type of the operation, the layout of the object, and permanence of the destinations of pointers. When a pointer is transferred to a temporary use, e.g. for a comparison operation, e.g. <, among pointers, then the destination of the pointer is known to be temporary or non-permanent, and hence a pad copy is not made. So long as the consumption of a pointer's temporary use is completed before the next deferred-free barrier is tested, the temporary use is safe and can be carried out. If the temporary use lasts longer, a permanent destination, e.g. comprising a variable, has to be used and a new pad created for the same.

Before attempting the read/write, pads needed for the operation are verified to be available from the local subheap. If the subheap cannot provide this many pads, a deferred free barrier is called to obtain the pads, inclusive of global space ceding option. A GC may also be triggered as a result of this.

A read or write may involve encodes or decodes and hence may throw an exception, similar to a bounds or temporal check. Details of encoding/decoding are given in a later section.

After reading the object layout, a read comprises:

read barrier-indicating multi-writer register, if barrier indicated, enter barrier, else:

do bounds/temporal check

Where-ever the object and read layout match, do a direct read off the object, ensuring each scalar reading comprises one atomic sampling at most. For a pointer being read into a destination, a pointer to a new pad copy or unique re-used pad is written in the destination. For a pointer reading with temporary use, the existing pointer and pad are used as is.

Where-ever the object and read layout do not match, do the above, except for encoding/decoding pointers during a reading as follows. If one or more pointers are being read as a scalar, then read the pointer(s) in one atomic reading at the larger of the alignments of a pointer or reading scalar, and decode the pointer(s) before transferring to the destination or temporary use. If one or more non pointer scalars are being read as a pointer, then read the scalar(s) in one atomic reading at the larger of the pointer or scalar alignment(s) and encode the reading as a pointer before transferring to the destination or temporary use.

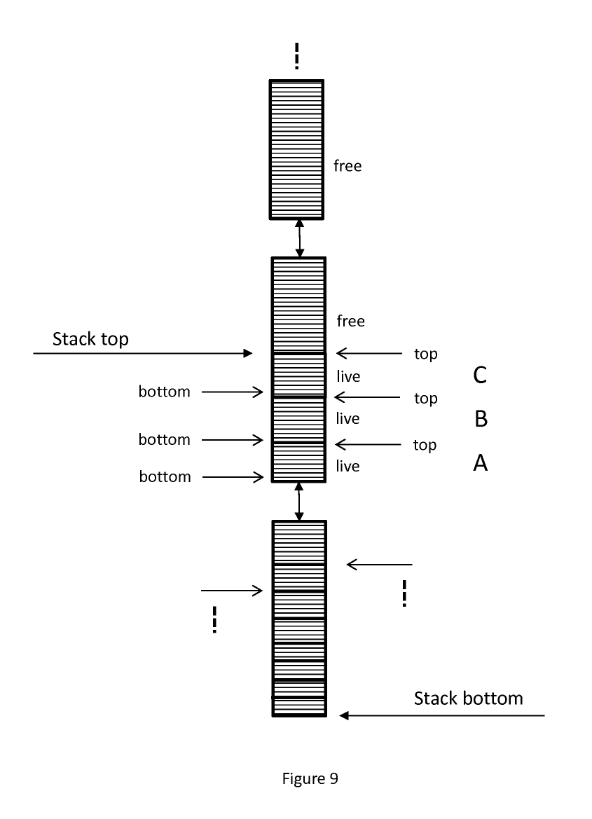

The encoding of a pointer in the above generates either a new pad or a unique, re-used pad. In the above, a unique, re-used pad can be generated for a stack-allocated pointer variable destination, discussed later with FIG. 9, wherein the variable has one new pad allocated to it in a stack frame that is then repeatedly re-used by pointer overwrites such as the one via this heap object read operation.

After reading the object layout, a write comprises:

read barrier-indicating multi-writer register, if barrier indicated, enter barrier, else:

do bounds/temporal check

Where-ever the object and write layout match, do a direct write on the object, ensuring each scalar write comprises one atomic writing at most. For a pointer being written into a destination, a pointer to a new pad copy or unique re-used pad is written in the destination.

Where-ever the object and write layout do not match, do the above, except for encoding/decoding pointers during a writing as follows. If one or more pointers are being written as a scalar, then decode the pointer(s) before writing them in one atomic writing at the alignment of the scalar. If one or more non pointer scalars are being written as a pointer, then encode the scalar(s) before writing them in one atomic write at the alignment of the pointer.

In any pointer write, read the pointer location just before the pointer write and save it till the end of the entire operation. At the end, just before returning, kill the saved pointers by reporting deferred frees on them.

The encoding of a pointer in the above generates either a new pad or a unique, re-used pad. In the above write operation, a unique, re-used pad is generated when the destination's unique existing pad is re-used by overwriting the entire pad with an atomic large block write, discussed later.

In the above read and write operations, the use of a shared NULL pointer is carried out optionally as follows. Before copying a pad to write a pointer destination, the pad is checked whether it represents NULL. If so, instead of copying, the pointer to the NULL pad is used in writing the destination. This forces a branching NULL check for each pad copy, which is an avoidable cost. So the option may not be followed if the user desires a NULL transferred by copying. If NULL is always transferred by copying, then that also eliminates a NULL check from pointer killing code (that ensures a shared NULL pointer is never killed).

The static analyses given in Varma13 eliminate/lift/share layout reading as well as bounds/temporal checking. These analyses can be used profitably in sharing read/write operation overheads across multiple operations to reduce total checking over-heads to negligible. Barrier checking can be coarsened and/or carried out at operation-level granularity regardless with trivial overhead. Pad copying and creation can be minimized by making a destination temporary by shifting/coarsening the barrier check so that the destination's use completes before the check.

Dynamic Layouts and Tagged Unions

According to an embodiment, an object layout or type means for identifying a pointer containing variable or location is disclosed.

According to another embodiment, the read or write operation uses the read-only property of a layout between epochs to be able to carry out reads and writes of scalars in an object atomically, despite the layout and the object occupying and being accessed from separate storages.

A read or write operation on a heap object consults the object's layout as discussed before to comply with its storage requirements, while retaining the desired (pointer/non-pointer) interpretation specific to the operation. It is possible to support changes to an object layout through the running of a program, as follows.

A tagged union system is disclosed. The system comprises an object layout or type means for identifying a union containing variable or location. The system uses a boxed means for implementing the union by substituting the union with a pointer to a box wherein the box specifies the tag of the union and its contents. The contents thereby get a fully unconstrained storage, despite being placed in a union that occupies the same space as the contents.

A tagged union method is disclosed. The method comprises an object layout or type step for identifying a union containing variable or location. The method further comprises a boxing step for implementing the union by substituting the union with a pointer to a box wherein the box specifies the tag of the union and its contents. The contents thus get a fully unconstrained storage, despite being placed in a union that occupies the same space as the contents.

Suppose the layout of an object is desired to be reset to a writing operations layout. In other words, in the linearization of an object's writings, say the layout of the object also evolves along the way the object is written. So if a non-pointer scalar is overwritten by a pointer, a pointer is how the result is stored, and the layout modified to remember the position as storing (an encoded) pointer. Allowing a layout to evolve may reduce the encode/decode flux in read/write operations during the running of a program.

Since an object may have concurrent access by multiple threads, a layout change requires a barrier to carry out. The barrier may be called by the writing thread in the example above, when it finds itself writing to an object with a mismatched layout. A layout change may also be explicitly invoked, by an operation to that effect, that resets an object to a new layout by re-interpreting (encoding/decoding) its fields and re-storing them according to a changed layout. Again, a barrier is needed to carry this out. The barrier may be implemented similar to the barriers discussed in the subroutines section previously. Note that a layout change barrier may be requested for multiple objects in one go, with a suitable command or procedure for the purpose. This would reduce the barrier overhead substantially per object and allow re-structuring of a computation periodically with such commands.

It is to be noted then, that between any two layouts changing barriers lies a period of read-only layouts, which are unchanged for the period. This means that in this period, a layout, even though separately stored from an object itself (accessed by a layout lookup for the object), can be sampled independently of the object and not compromise atomic read/writes of the object. This separate sampling of object and layout data, and yet atomic object operations transpires because the layout data is kept read-only. By ensuring read-only layout epochs between layout changing barriers, our design enables atomic, synchronization-primitive-free read/write scalar operations over objects, which do not suffer from deficiency B discussed in Varma12.

A barrier per layout change may be acceptable when the changes are few. For an idiom like unions, this may not be acceptable. For unions, we present boxed values, reusing pointer pads as follows.

A one-word value may be a pointer (viz. encoded by a box) or a non-pointer (viz. decoded). By encapsulating that word in a pad, whose version field is re-used as a boolean to identify pointer/non-pointer, the pad can be a box for that value. The value field of the pad can store the actual value viz. the un-encoded scalar itself, or a pointer to a pad.

The layout for a pointer-sized area of storage now comprises three options: B, P, or U, where B stands for bytes or non-pointer; P stands for pointer; and U stands for union or the box discussed above. This layout generalizes the layout of Varma12, from B and P values to B, P, and U. An object's layout, after allowing all unions in its type (unlike Varma12), is a sequence of B, P, and U values, representing pointer-sized storage chunks (i.e. word-sized chunks since a pointer is word sized here), that commit each pointer-sized location in the object (at pointer alignment), to holding either a non-pointer (B), a pointer (P), or a box of either (U). This layout flattens a nested struct/union type definition to word-by-word definition according to whether a location always holds a B, always holds a P, or may hold either. Then the accesses of these locations is carried out according to this layout fixed for the object. Just like the read/write operations discussed in detail above without unions, reads and writes with unions transpire in pointer-sized atomic samplings/writings, to transfer data to and from objects on the heap or stack/registers (e.g. locations or variables using pads or local_pads as discussed earlier). Box creation and killing follows straightforwardly and analogously to pad creation and killing discussed earlier.

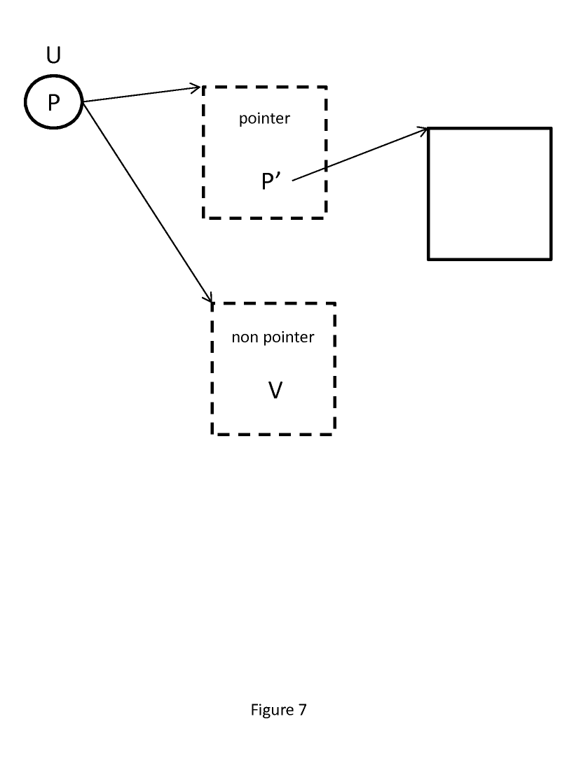

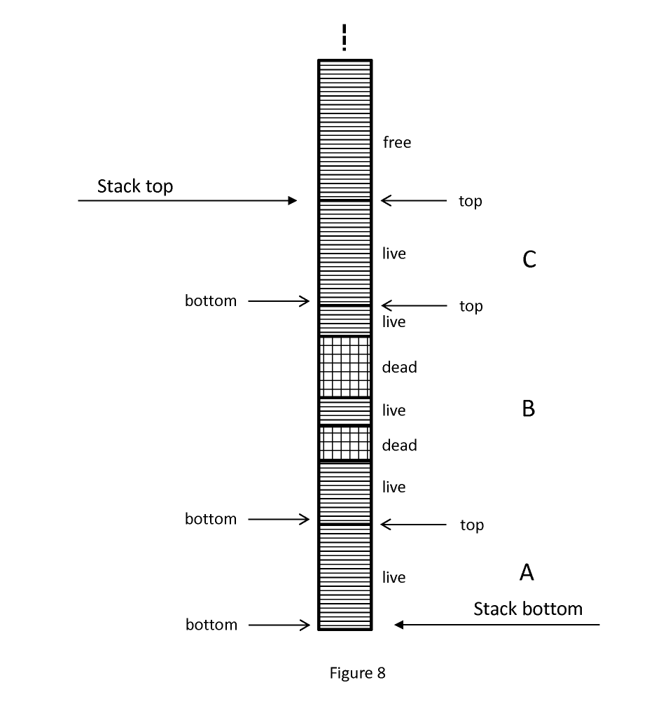

FIG. 7 shows the implementation of tagged union by overloading the pad mechanism. Pointer P is stored in a variable or a location that is identified as a U, a union-storing location either in a layout (if a location, viz. contained in a heap object), or type (if a variable, viz. stored on the stack or a register). P points to one of the two dashed boxes shown as options. In the upper box, a pointer is contained. The upper box is labelled as a pointer-containing box by its version field. The box contains a pointer P′ to a regular pad for pointers. In the lower box, a non-pointer V is contained. The version labels this box as a non-pointer. The upper and lower boxes are regular pads for pointers, but instead of storing pointer data, they are overloaded to act as boxes for the tagged union. The tagged union, very capably, stores a wordful of un-tagged information in a wordful of space (the pointer P). Thus backward compatibility to legacy code (viz. porting standard, un-tagged code to the tagged union) is highly preserved. The involved pads, all the three boxes in the figure can be either (optimised) stack pads (FIG. 8, 9), or usual pads (FIG. 4).

By re-using pointer pads as boxes in unions, our system simplifies memory management and keeps only one large pool of pads around for all uses. An alternative choice of course is to use a slightly stripped down object for a box, as it only carries a boolean and a value. The tradeoff then is in the increased complexity of memory management and the partitioning of memory into multiple pools, which may not be desirable.

Varma12's invulnerable pointers derive their power and also their limits from their read-only nature. By allowing layouts to be changed at barriers with read-only epochs in-between, our system adds changeability to invulnerable pointers. Already, by automatically encoding/decoding data to fit a layout, our system relaxes the rigid separation of pointer and non-pointer data that invulnerable pointers enforce. If the rigidity however is required, then, by denying automatic encode and decode (let them throw an exception), invulnerable pointers as per Varma12 can be obtained.

Decoding and encoding of pointers is discussed extensively in VarmaB. The system here follows that teaching straightforwardly. An improvement to encoding can be carried out as follows. Given a marker in the object0 metadata (FIG. 4), fixing a putative object's position is carried out using that marker (as per Varma12). The putative object can be run backwards from along its putative links, increasing confidence exponentially as the traversal proceeds. Now how far to search for an object-fixing marker is an open question. This can be solved as follows. Run through big allocated objects directly in a subheap, since they are likely to be few. That fixes the largest object size remaining that needs to be searched by marker. Now traverse backwards up to this-sized object for a marker. The marker search and large objects enumeration can be interleaved to speed up the search. This should reduce encode complexity to linear in practice.

Encode safety: encode traverses live objects of all processes following Varma12. This happens concurrently while the lists are being updated. This needs to happen safely. The deferred free design in the present system ensures the safety, since all encodes transpire outside a deferred free barrier. However, immediate frees, for sequential non escapee pads, and object allocations may transpire in concurrence with an encode, making it unsafe to traverse the links of objects. This problem is solved by restricting it as follows: a thread may encode a pointer only if the pointer is local to the thread's subheap. Otherwise, the encode throws an exception. Now, encodes become safe for all uses and efficiently so. The encoding of non-local pointers may be relaxed as follows. For a non-local pointer, a thread may encode a pointer only if it has decoded a pointer to a putative object pointed by the pointer being encoded and that object is live at the time of encoding. This condition may be established by looking up in the thread's encoding/decoding cache, a putative object fixed by its marker. The user may specify the cache size for this purpose as a compile time flag. If the cache has overflown and the decoded object is not there, the pointer may not be encoded.

Encodes to a pad object are disallowed; they fail with an exception. A user may not acquire a handle on a pad by an encode.

Optimising Boxed Pointer Operations

According to an embodiment, a new or unique box is used for each non-NULL pointer stored in a variable or location.

According to another embodiment, the unique box is obtained by a sequence of box-reusing, content overwrites of a new box used for the variable or location.

According to an embodiment, a means for identifying stack and register allocated pointers by re-using an allocated box collection is disclosed.

According to an embodiment, a means of allocating or de-allocating boxes in bulk for sequential or concurrent use is disclosed.

According to an embodiment, a means for creating or destroying a box branchlessly is disclosed. The means comprises allocation, initialization, or de-allocation, or the use of multi-word reads and writes.

It is important to reduce the cost of creating a boxed pointer copy in pointer updates. There are two approaches: (a) use multi-word writes to fill a box, e.g. doubleword; and (b) use hardware pipelining effectively by avoiding branches in allocation/deallocation and box filling codes. To do this, using the analyses in VarmaB, occasionally, at large granularity, the number of pads available in the subheap pool can be checked. The next set of allocation calls can proceed then without the pad availability checking code, and hence allocate with branchless code. Another advantage in favor of pads is that unlike objects, no spatial/temporal checking of pads is necessary; this aids branchless processing of pads, e.g. in de-allocation. Since pool management of pads is subheap local (viz. sequential), it is straightforward to optimize it for branchlessness, e.g. by keeping sentinels at the ends of the allocated/free lists to eliminate branching checks for running off the end of a list.

Sequential, non escapee pads (viz. variable pads) can be kept separately from pads used by (heap) locations for optimization as follows. In a long jump or exception, when pads with higher framecounts are disbanded, then, if the allocated list only comprises local_pads, then it can easily represent pads in allocation order, which is a stack (LIFO), as per procedure calls. Disbanding pads then simply means resetting the stack top to a lower top in the stack of pads, and shifting the disbanded pads list straightforwardly to the free list. Popping a stackframe (returning from a function call) behaves similarly, for a frameful of pads. Pushing a frame (function call) is simply shifting a free pads (doubly-linked) list to the pads stack, from the free list. Without assignments, pad management is simply as discussed above. In any frame, only lexically-scoped variables are visible, so pads on the lower frames, which comprise a dynamic scope, are simply not visible. So assignments, if they occur, only kill pads of the highest framecount on the pad, replacing a pad on the stack with another. The killed pad need not be moved as a part of the kill, simply one pad gets added on the stack to represent the assigned pad. Thus the topmost function instantiation on the stack has a growing frame representing its live/killed pads at any time. When the function returns, the entire possibly increased set of pads representing the function's frame is popped as a group off the stack. The stack of pads, therefore represents increased frames of killed/live pads on the stack, ordered as frame sets (for stack frames) on the stack. In this organization, a local_pad can be optimized away and replaced by simply pads (without framecounts). The local variable in a procedure representing the procedure's framecount is now replaced by two local variables, one pointing to the lowest pad for its frameset (the first pad allocated for the frame), and a second variable representing the top of the frame at any time in the procedure. The top of the stack moves as assignments occur. When a procedure call occurs, the called procedure's frame_bottom variable points to the pad just after the calling procedure's frame_top. Now when a long jump/exception occurs, the list of pads above the destination (of long jump/exception) procedure's frame_top are freed. In the organization discussed thus far, a local pad stays on the allocated LIFO list above, but is marked live or killed as computation proceeds. This may be done in a variety of ways, including a dedicated boolean field for the purpose, or re-using the version/size fields in pad meta-data.

Now note that a frame bottom and frame top are not needed per procedure. They are only needed per procedure that stores pointer variables (viz. pointers on stack or registers). This reduces the overhead of these local variables substantially. Note further that the list of pads in which the stack expands and contracts does not need list insertions and deletions at all. This is because only the frame_top and frame_bottom pointers from procedures are updated as the stack evolves. Individual pads have their status set to allocated/free, with free representing a dead pad and allocated representing a live pad. When stack is popped/unwound, the freed pads do not need to have their status explicitly reset. Only when a pad is allocated (this of course occurs within a frame bottom and top), does it need to be set to allocated. When it is killed by a pointer overwrite, it is set to free. This architecture suffers very little overhead, the only manipulations the linked list suffering being obtaining or returning lists of pads from the subheap pool when stack growth or heap objects growth demands it. A stack_top and stack_bottom variable also have to be kept, for example for GC's use. Stack_bottom once set, never changes so that is cheap to include. Stack_top changes frequently, as frequently as the top frame's frame_top. To minimize the effort duplication, only the stack_top needs to maintained current, with the frame_top being made current just before a new frame is pushed (e.g. by a procedure call).

FIG. 8 illustrates the stack, comprising three stack frames A, B, and C (C on top). Frames A and C are shown as functional frames, with no overwriting assignments to pointer variables. Hence all pads for the frames are live. Frame B illustrates an expanded frame, including dead pads resulting from overwrites of pointer variables. An important property of any frame is that the number of live pads is equal to the framesize, regardless of the number of dead pads. Each frame's top and bottom pointers are shown, besides the stack_top and stack_bottom. Beyond stack top are free pads. All the pads are arranged in one long doubly-linked list, among which only the various top and bottom pointers are adjusted, besides setting of free/allocated status of pads.

The above enterprise can well be carried out on the system stack itself, using stack-allocated pads as opposed to heap-allocated pads. This option however suffers from still having to create a linked list of the pads, which becomes a linear-time extra exercise in each stack expansion or contraction (e.g. procedure calls), which is unneeded.

Note that in the discussion above, the allocated pads for sequential non escapees are managed separately as a stack (run off a doubly-linked LIFO list) compared to the allocated pads for heap objects. Does this bifurcate the pool of free pads into two disjoint pools with concomitant inefficiency? We answer in the negative. The free pads remain one common pool to allocate from. Indeed, the dissolution of local_pad structure into a simple pad enables this pool sharing and the free pool simply serves singleton or larger lists of pads as units of allocation or de-allocation.

Note further that the highly-structured stack behaviour shown in FIG. 8 can be leveraged further to strip down a local_pad to a much lighter object, even lighter than a pad. In this object, the underlying object0 meta-data is completely dropped, eliminating the doubly-linked list structure as one example. The ability to drop object0 comes from the lack of a need for its fields. The pad structure solo can be allocated as contiguous elements of a large array representing stack pads. The pads grow and contract, as discussed above and shown in FIG. 8. Linked traversal is simply not needed, going up and down the array suffices as needed. Given an array allocation of pad structs (FIG. 4), comprising a separate pool of pads, the other meta-data is not needed as follows: size—unneeded and no deferred frees are carried out; pid, unnecessary, as this pad is fixed in the local thread's stack only which already knows the pid; overlapped marker, unnecessary, since GC can treat stack pads in the root set distinctly, without using marker bits and encode/decode on pads is disallowed; version is irrelevant for pads. Only the allocated/free flag needs to be salvaged from object0 metadata and surfaced in the pad structure. For this, note that a base pointer points to doubleword aligned objects only. In other words, several lower bits of the base pointer are redundant (4 on 64-bit machines, 3 on 32-bit machines). One of these bits can carry the allocated/free information. Since code to access an object via a stack/local pad is explicit in source code, the code can be customised for treating the base pointer differently (to separate the allocated/free information).

By dropping object0, the space cost of a pad is reduced to ⅓. This is a large saving, that reflects both in space and time. To reflect stack growth, additional arrays can be allocated dynamically, or the standard linked pads with object0 leveraged. Generally, a user can tune his program by specifying the stack's array size as a compiler flag. The array may well be allocated off the system stack in an early call. Additional array allocations may also be made off the system stack by later calls. Thus local pads may be run completely off the system stack as disclosed here.

Next, note that all the sequential, non escapee pointers represented on the stack have no concurrent access. Therefore, there is no need to atomicise them. So when a pointer on the stack is overwritten, the overwriting pointer can very well re-use the pad of the pointer being overwritten, as opposed to re-allocating a new pad. This observation eliminates all the dead pointers present in FIG. 8 as a result. The pointers for a stack frame, once allocated, are repeatedly re-used in every update and a dead pad never arises on the stack. Given that a dead pad never arises, the need for a flag bit (live/free) on a pad disappears, and the base pointer no longer needs to supply that. Pre-supposed in this exercise of course is that a NULL pointer on the stack is implemented by copy; when a pad is overwritten by NULL, then instead of re-using a global (heap) pad for NULL, the stack pad's fields are filled with the NULL pointer's fields (base, version, value). This is an extra cost that the system now endures. The cost is minor however, overwriting by NULL means a 3 word write branchlessly. Null checking is the same cost, e.g. base pointer check. Note that the extra cost is circumventable of course: if the platform supports 4-word alignment and writes, then, after rounding each pad's space to 4 words (e.g. there could be extra fields in the pad, like the UPC processor field mentioned, or a word used extra anyway), a NULL write is simply one write. Having 4-word alignment would help other pad writes also. Another way to eliminate NULL treatment is to resurrect the live/free flag, with the free setting indicating a NULL pointer. The fields of the NULL pointer need not be populated.

Now there are no update related pads on the stack. The pads on a stack frame comprise only pads lexically apparent for the related procedure. The size of a pads frame is now a static constant, per procedure. The stack of pads now does not grow because of updates in a loop within a procedure, for example with pointer arithmetic. The stack only grows because of a long chain of procedure calls, as per the normal growth of the system stack. So the stacks pad can now be made to mimic the system stack very carefully, as shown in FIG. 9. There is no need to allocate a huge array at the outset. The stack of pads can grow and contract, like following the nature of computation, as opposed to prior budgeting.

The easiest way to implement a stacks pad is building it as a linked list of medium-sized arrays, the sequence of arrays representing what the huge single array did earlier. Before a call is made to a procedure requiring a pads frame, the space on the current array is checked. If it is not enough, another array is allocated and the linked list expanded and the call made with the frame on the bottom of the new array. In stack contraction, an array can be returned when the stack vacates it. The checks for array space can be granularized straightforwardly, for instance an array allocation being made for an entire chain of recursive calls, as opposed to call-by-call. Note that the size of individual arrays can vary (a size of each array is tracked along with the array), so that the arrays allocated for the stack by the subheap can be sized according to availability, as opposed to a demand. An array, once de-allocated is straightforwardly re-usable for all other allocations by the subheap.

Slightly more complicated, but more consistent with normal stack computation is to allocate the pads arrays on the system stack itself. For this, the program has to be translated to a continuation passing style (CPS) form, so that when a check determines an array allocation, the array is allocated by a procedure call for the purpose that also takes as argument the continuation comprising expression/computation that is to be executed in the context of the allocated array (e.g., the function call for which the present allocated space was deemed inadequate). The procedure allocates the array and calls the continuation before returning, so the continuation executes in the context of the array already allocated on the stack. When the continuation returns, so does the procedure, de-allocating the pad of stacks. In this case, the entire space of pads is carried on the stack, disjoint from the subheap pads.

A pointer variable may not be in scope or un-initialized at a point in a procedure. The pad for the variable can however be initialized to NULL pointer (by copy) when the stack frame is constructed so that the pads at any time carry meaningful data (e.g. for use if a GC is triggered). A variable, when it goes out of scope within the procedure may continue to manifest the last populating pointer in its pad to avoid pointer killing work that for instance could be carried out by setting the pad to being a NULL copy. For ensuring precise kill accounting in GC, such NULL setting may be carried out in case GC is triggered, and only then. This would reduce killing costs to frame popping alone and yet obtain very precise GC.

FIG. 9 illustrates the stack of pads comprising live pads alone and fixed stack frames. Contrast this figure with FIG. 8 having A, B, and C frames also. In FIG. 9, the stack is made of a sequence of medium-sized arrays that reflect the state of a thread's stack closely, besides also optionally being allocated on the thread stack itself.

Next, it is to be noted that heap objects offer bulk allocation of pads also, based on their layouts. Note that a heap object, when it acquires a layout (Varma12), has all pointer slots set to the NULL pointer. As one option, in our system, the NULL pointer is a shared, read-only, never de-allocated pad pointing to NULL. A kill on the pad simply ignores the kill (no pad freeing occurs). When an object is allocated, this pad populates all pointer slots initially. Pad population with non-NUll pads is incremental in an object, but can well happen in a loop for the object, in which case, the bulk allocation for the loop would be a sublist of (unshared) pads. An easy idiom to optimize this for is the allocation and initialization of a heap object intra-procedurally in a thread (e.g. in a loop). For this a bulk allocation using a sublist of pads for the object can be carried out. The bulk allocation is ordered, with the pads in the sublist corresponding to the order they follow in the layout, the first pad in the layout also being the first pad in the sublist and so on.

Analogous to the stack pads above, pads for a heap object can be tracked for bulk de-allocation also, using bulk allocation as described above. Note that the bulk allocation comprises pads allocated by one thread only. For de-allocation, some variant of this sublist has to survive for de-allocation by the same thread. In the interim, since the sublist can only be altered by the same thread, the pad overwrites should be local so that the result is fully tracked by the sublist. Such a pattern suits single-writer, multi-reader idioms well. So if an object is written solely by the allocating thread and made concurrent solely for reading by others, the object is very suitable for bulk allocation and de-allocation. For the time being, let's assume that the pads are all non NULL and so are unshared pads and hence a part of the sublist.

In this case, each overwriting pad can be allocated just before the pad being overwritten by the single thread (in the sublist). A deferred free then later makes the killed pad as non-allocated, as usual, except it does so by marking thus, and not by moving the pad to the free list, so that the move can be done cheaply later by a bulk de-allocation. The deferred free can of course move the pad in the same stroke, by removing it from the allocated list and putting it on the free list, but this would reduce the bulk de-allocation benefit later. The deferred free can choose its action on whether its working thread has free polling cycles available to do this extra work or not. The decision can also be dictated by the free pool of pads available with the thread, a small pool indicating that the pad be moved.

To distinguish pad killing in this idiom from pad killing elsewhere, this idiom can be identified by say the object layout involved. If a layout is selected as a bulk-deallocation layout, then, its pads are allocated on a distinct list from others. This list contains both live and killed pads on itself, with the killed pads being freed (i.e. moved) either at the killing time, or later. An object de-allocation, when carried out will of course shift the live and any (remaining) killed pads pertaining to it together in one bulk de-allocation. The layout informs the de-allocations to follow this bulk route, and it also informs the object writes to follow this idiom. The bulk de-allocation frees the sublist from the pad of the first pointer (as per layout) to the last pointer (as per layout). Since this ignores the killed pads for the last position, the freeing can extend to include all the contiguous killed pads after the last pointer. So in one sublist cut and splice, the pads can be shifted from the allocated list to the free list.

Now consider the presence of shared NULL pads on the list. In this case, after a NULL occupies a slot, then the next non-NULL overwrite does not know its position in the pads sublist. For this, the allocation can go to a nearest non-NULL live pad surviving in the list to locate the sublist. The new pad has to follow the layout/sublist order and be allocated ahead or behind the non-NULL pad according to the order. The allocated pad can be added adjacent to the non-NULL pad since there are no live pads between the new pad and the non-NULL pad (all of them have been killed by NULL overwrites). Suppose no non-NULL pad is left in the sublist. Then this sublist is abandoned and a new sublist started, with a singleton non-NULL pad comprising the sublist. Later additions add to this sublist in proper order.

Since killed and live pads reside on an allocated list, they are distinguished by a tag bit for the same. As discussed before, the tag bit can either be explicit in the object (e.g. a version bit, reducing version space), or it can be lifted out from spare bits (e.g. the base pointer field that points to doubleword aligned objects only, leaving lower bits unused). Note that a pad killing does not alter its tag immediately. This is carried out by a deferred free. So a live-tagged pad cannot be trusted to be a non-killed pad, but a killed pad is conclusively known. A killed pad can be shifted from the allocated list to the free list at any convenient time, including the bulk de-allocation time. Killed tagged pads can be cleaned up proactively, e.g. when pads are needed and the free pool is empty, or in waste times, e.g. polling times, or as per user-specified policy. These cleanups are also needed, given that a sublist can be abandoned due to NULL overwrites, with no handle left on its killed pads.

Bulk de-allocation of a NULL containing object then comprises locating the extremities of non-NULL pointers in the sublist. From the starting extreme, all preceding, contiguous killed pads are included. From the ending extreme, all succeeding, contiguous killed pads are included. This enlarged list may be deleted altogether by the bulk de-allocation.

A single-writer, multi-reader idiom may be violated by occasional concurrent overwrites. The pointers of a non-local write are similar to a NULL pointer in residing outside the sublist. Their treatment is identical to the NULL pointer treatment. A non-local pointer can overwrite a slot any time, asynchronously, so sampling of a sublist pointer to order a new pad allocation in the sublist can be negated by a non-local overwrite. In other words, the liveness knowledge of the current pointer slot's local pointer (the one being overwritten), or a nearest “live”, non-NULL, local pointer can be stale. Regardless, as far as sublist management goes, this stale sample is still accurate for the sequential sublist management being carried out by the local thread, regardless of any fresh kill notice headed this way by a later deferred free. The new addition can be validly carried out using the stale information. This enables continuation of the sublist even in cases when it is completely overwritten by non-local overwrites, barring the newly added pointer. Thereafter, if the newly added pointer is also overwritten, then the sublist is abandoned, analogous to the complete NULL overwriting case.

In summary, based on layouts, the bulk de-allocation idiom can be identified and catered to. This idiom is best suited to single-writer, multi-reader scenarios, but works for all concurrency cases anyway. A user can specify the layouts that he wants treated by this idiom. A compiler analysis may also identify layouts that are roughly single-writer. NULL processing, if by a shared NULL pad detracts from the bulk de-allocation idiom. This can be improved by not having shared NULL for the identified layouts and instead using unshared (copied) NULLs for the layouts. Otherwise, the choice of layouts can be reduced to minimize the presence of NULLs in objects. Regardless, the idiom handles NULLs safely for all layouts. For performance gains, a non-NULL, single-writer, multi-reader idiom leverages this idiom the best. Bulk allocation may also be de-linked from bulk de-allocation and be carried out by itself.

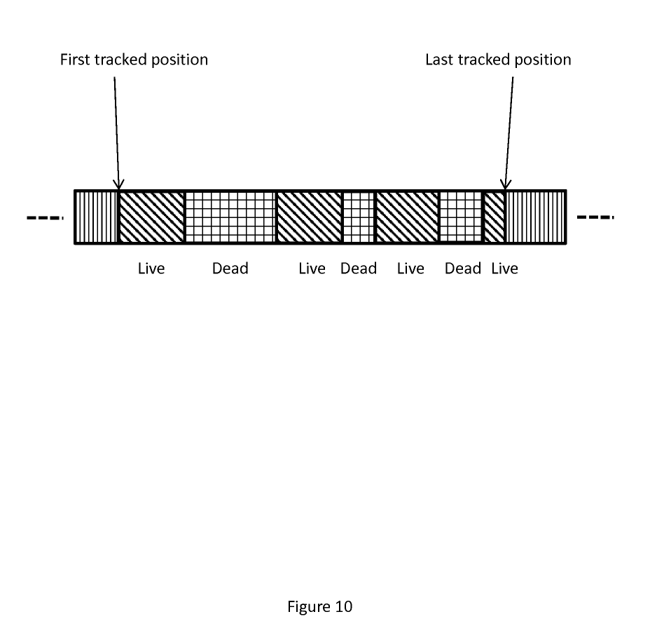

FIG. 10 illustrates the bulk allocation and de-allocation for a heap object. A sublist of pads in a doubly-linked list of pads is shown. The sublist lies between a first tracked pad and a last tracked pad for a heap object. Deferred cleanup is shown, with the sublist comprising both live and dead pads. When the object is freed, then the entire sublist is freed and shifted to the free list.

An escape analysis for heap-allocated objects can usefully tell whether the object escapes a thread or not. If an object is established to be sequential, then its deferred frees can be substituted by immediate frees. This can be of much use in getting rid of barrier costs from heap-shifted stack objects. Intraprocedural escape analysis is straightforward and could nicely suffice for such objects. Interprocedural analysis, that focuses on upwards escape (e.g. procedures called with the heap-shifted object as an argument) may also establish sequentially profitably. When escape analysis establishes a heap object as thread local, it also establishes its single writer status. This can drive the above bulk de-allocation optimization also as the compiler analysis for the purpose.

Tuning work applicable always to recover waste time (e.g. polling time) comprises creating sets of free pads of different sizes to bulk allocate for objects. This would be driven by object size and layout and initialization pattern for the object, which commonly would comprise a simple, intraprocedural analysis for the purpose. Once the sizes to bulk allocate are known for a given object size, the management structures for that object size (Varma12) would also cache allocation set pointers in the free list for the sizes, to speed up such allocations later.

Implementation Notes, Complexity and Performance

According to an embodiment, a source-to-source transformation means for complete implementation is disclosed. The means provides enhanced portability and integrated performance as a result.

At the outset, note that the present disclosure does not crimp virtualization of garbage collection at all. Pads work without the intervention of GC and do not add dead objects for the garbage collector to collect. There is of course, the tiny chance that racing concurrent writes can create some dead pads for GC to collect, but this is a rare scenario. For this scenario to play out, repeatedly, to fill up the heap is highly unlikely. So virtualization of garbage collection, further improved by the provision of large versions for objects (full fields, as opposed to bitfields), and the elimination of the need for version recycling analysis by provision of a precise garbage collector means that complete version recycling occurs trivially and has large versions, implying that virtualization if anything is only improved in the present system.

From an implementation perspective, one major advantage of the disclosure is that the system can entirely be implemented as a source-to-source transformation. There is no need to resort to assembly programming to inspect registers for garbage collection. There is a need to make the compiler behave safely for concurrency, for example to provide the necessary relaxed sequential consistency semantics for the concurrent program specification. This can be obtained using volatile qualifier for say the polling variables and atomic registers in the code. It may even be possible to force the compiler to provide the desired behavior using the careful placement of dependencies. For example, polling in a loop is wasteful; by placing useful work between each reading of a variable, and making the variable global, the compiler may sample the polling variable afresh each time as opposed to re-using a past read value. This would allow the compiler to continue high optimization, while yet providing the consistency semantics.

The implementation can reduce caching cost (space, time) for deferred frees by avoiding much of the deferred free caches altogether. Instead, an object to be defer freed can be stored in relevant pc buffer directly. For an object to be defer freed by a thread itself, locally, a cache has to used for the thread (there is no pc buffer to oneself). Defer frees can be partitioned into two distinct parts—pads, and objects. Each cache/pc buffer can analogously be partitioned into two parts, the sizes of the parts being user specified. For instance, the filling threshold for pads may be high, compared to objects.

The system, as described here is not a non-blocking system. If one thread dies, all others dependent upon it in a barrier will block forever. It is not clear whether thread-failure resistant programming is the right model to implement in a programming system, as here. Regardless, the system here, can be made non-blocking against thread failure as follows: each time a thread enters into a polling mode and blocks, e.g. for a barrier, it can start monitoring the thread(s) it is dependent upon. It can, for instance, signal an exception, after waiting a long time for a thread to respond that ordinarily should have responded in a tiny fraction of the time. To do this, the thread after polling a bit can start a timer (with a system call, or by usable computation otherwise) and if no answer occurs within a stipulated time, throw an exception.

Byte by byte copy, by memcpy( ), in the context of this system would read according to an object layout, decoding pointers if any along the way, to save pad-agnostic data in a bytes destination. If the destination specifies a layout with pointers, the intermediate bytes would get encoded as pointers in the destination, with new pads. Optimizations to this basic process are straightforward (e.g. for matching layouts, the source could be copied to the destination without encodes and decodes along the way, with pad creation upon copy as necessary).

The NULL pointer may be implemented as a dangling pointer to a never-deleted NULL object, as given in Varma12. A function pointer may also be implemented as per Varma12, with function type information carried in the object associated with the pointer so that function pointer calls are typed. Variadic functions are typed, e.g. as per Varma12.

Consider the worst case scenario of pad allocation and de-allocation to space as opposed to a pool of re-usable pads. In either, there is no layout to create, no NULL pointers to initialize or dismantle. So even from scratch, this is cheap.

The discussion on object allocation and de-allocation, largely eliminating pad allocation and de-allocation costs from the same can speed up the few cases that are object allocation/deallocation intensive. Generally, the dominant cost in a computation is not object allocation/de-allocation; regardless, the case has been streamlined as given earlier. Sequential, non escapee pads, used by the stack are a far more important cost to optimize, which, has been done with both stack and heap allocation of pads.

The barrier as shown in FIG. 2 is highly efficient. The cost of the barrier lies in event number 2, in which all threads first synchronize. Event 5 can also be costly, if the work of the winner thread is made large, forcing other threads to wait for their FREE status. In general, it is desirable to keep the winner lightfooted, so that the FREE status for other threads is set before they finish their works.

In the context of hardware support for cache coherency, polling of the barrier registers will not cause network traffic, with the hardware bringing the caches into synchrony with minimal traffic. For software synchronized caches, the polling may be optimised as per prior art to reduce network traffic.

With the cost of a barrier reduced to simply event 2, a barrier cost is the longest time it takes a thread to switch to the barrier, which is the sampling period of the multi-writer register for individual threads.

A deferred free is infrequent; with pads recycling however, its frequency increases; so by having large pad pools, large deferred free caches one can keep the system efficient. With guaranteed large work per barrier (cutting overhead), and with waste recovery (polling time converted to pool improvement), the system is fast. Now how much pointer churn is there ever? Very little, as many heap objects are largely static pointers in graphs and for the local ones, the immediate frees require no barrier. So, the cost incurred for barriers is likely very limited.

As discussed earlier, with static analyses as per VarmaB, the safety checks cost becomes negligible. Indeed, Varma13 argues for speedups, based on the better implementation of a safe language, with safe strings (e.g. strlen( ) is pulled off based on bound lookup as opposed to traversing a string linearly); hence with the given analyses, even a speedup may be realizable.

Concurrency is difficult to use beneficially. In the present disclosure, since threads are totally decoupled, viz. they only access atomic registers and communicate with each other exclusively using such registers, the communication does not create hotspots in the underlying network by the use of special primitives. The run-time is well behaved, the synchronization constructed out of atomic registers (e.g. barriers), minimal in cost, with polling time used to tune memory pools. The open question is whether the safe, concurrent system with useful properties (e.g. one object's pointers cannot alias with another object's pointers, reads and writes for all scalars are atomic) can altogether offer speedups also to a common program compared with the same program on an unsafe platform? If so, how much will such a speedup be?

Finally, note that in the context of C/C++, the system here provides a safe, relaxed-type-safe, concurrent ANSI C/C++, with virtualizable GC, supporting arbitrary fat pointers, maybe with performance gains over ordinary C/C++. In providing relaxed type safety, a read/write operation has automatic encodes and decodes performed on the pointers it transfer to/from an object, according to the object layout. This is a major novelty of the system over prior art. Note also that with pointers getting boxed without introduction of tags in the pointer to a box, a representational alternative emerges for pointers in compiler systems and virtual machines for programming languages. The same can be said for the tagged unions offered here, where no tags crimp the pointer to a box and the entirety of a union value (one word) is preserved, the tag being carried in the box, without constraining a base value itself.

Explicit Pad Management with Reference Counting

According to an embodiment, the boxed pointers comprise pointer boxes that are unshared, or shared with reference counting, or shared with an implicit infinite count.

The system as described so far does not do reference counting of pads in an attempt to share them and reduce the memory footprint. The reason is when a heap location's pad is killed, multiple writers may report competing kills on the same pad, with the system having to reconcile the kills into one kill and then decrementing the pad's reference count by one. Now since the pad is shared, and multiple kills are reported on the pad, it is not clear if the kills are all coming from the same location. If they are, then the kills need to be reconciled into one, otherwise, maybe not. To handle this, kill reporting now has to start sending a pad and location pair for each kill. This increases the reporting costs. Next, in reconciling, the kills for a pad have to be sorted location wise, with kills per location being turned into one kill apiece. Finally, it is also possible for a shared pad to be killed in one location, then copied back into the same location again and killed again. Now the kills for the location have to be grouped into two distinct sets, one before the copyback and one after. This is again do-able by partitioning the kills thread wise, with two kills reported by a thread for a pad on the same location counting as two distinct kills.

By building additional machinery as described above (track locations for kills, count multiple kills of a pad on one location by one thread separately), reference counting pads can be built for reducing the number of pads in circulation at any time. A reference count field is needed per pad of course to implement the mechanism. To keep reference counting unsynchronized, it is desirable to allow only one thread to do all the increments and decrements of the reference count. For this, it is nice if all the pads in one subheap's objects are obtained from the same subheap, so that the subheap's thread alone is responsible for maintaining reference counts. To do this, each time a pad is written in the subheap, the pad has to be obtained from the subheap e.g. by pointing to a shared pad in the subheap and increasing its reference count by 1. If a remote thread is writing a pad to this subheap, it can well write a pad with reference count 1 as an unshared pad at the outset (to avoid synchronizing with reference counts elsewhere).

Now to provide one subheap's pads to another thread to write in the subheap requires the pad pools to be organized for multi-threaded allocation. For instance, the free pads from one subheap can form one free list per thread, with any given thread having a pointer in the free list as the place from which it will next pick up a pad. The pads behind the pointer are allocated pads, while the pads in front of it are free and yet to be consumed by the thread. The subheap thread endeavours to collect dead pads behind a thread to recycle them in front of the thread. It endeavours to keep each thread supplied with long lists of pads in front of each. This design can work with great efficiency, (allocation is simply advancing one's pointer in the list and marking a pad as allocated; de-allocation is simply marking a pad as de-allocated while leaving it untouched on the list for the subheap thread to pick up later), however, it does suffer from a pre-partitioning of a pool's pads into K lists, for total K threads. By contrast, the unshared pads discussed before are simpler and have all free pads organized in one pool.

Reference counting pads can be further improved by lifting their common data (for an object they all point to) to a common subobject for all the pads. This common subobject can comprise the version number for the particular lifetime of the object being pointed by all the pads. It can comprise the base pointer to the object. So for each allocation instance of an object, this common subobject can be created and pointed by all pads. The subobject can do its own reference counting. When all pads for this subobject are gone, then the subobject can be reclaimed. Since an object can be shared by multiple threads, the reference counting of the subobject has to synchronize different threads, or keep a distinct count per thread in an array of counts, e.g. keeping one char's space for each thread. Either choice has its own difficulties.

Large Block Atomic Writes

According to an embodiment, a new or unique box is used for each non-NULL pointer stored in a variable or location.

According to another embodiment, the unique box is obtained by a sequence of box-reusing, content overwrites of a new box used for the variable or location.

According to an embodiment, a means for creating or destroying a box branchlessly is disclosed. The means comprises allocation, initialization, or de-allocation, or the use of multi-word reads and writes.

The pointer design, as a boxed pointer enables large data to be stored for the pointer in its box. The scheme furthermore, can leverage large block atomic writes very usefully, if available as shown here.

Suppose large blocks can be written atomically in the language/machine available. For example, consider the cases of 4-word atomic writes, as discussed for stack pads earlier. Suppose the entire pad can be overwritten by such an atomic write. Supposing 4-word writes, a pad can be 4-word aligned and atomically written and read. The stacks case is already discussed before. For the heap pads, the situation evolves similarly as stack pads. For a pointer location in an object, according to its layout, only one new pad ever be written. The pad can be re-used for all pointer overwrites to that location, by overwriting the pad data with the large block write. When a thread reads or writes a pointer, then after atomically sampling the pad, the thread only need to sample the pad data into a local copy atomically before accessing the innards of the local copy. A write similarly, overwrites the pad data atomically.

Given the read-only layouts of objects in read epochs, each pointer slot in an object can be guaranteed to have a pad dedicated to it throughout the life of the object in the epoch. For this, the NULL initialization of the slot before allocation has to be modified. The NULL pointer can no longer be a shared pointer. It should be a fresh copy of the NULL pointer, dedicated to the slot in the object. This pad handles all updates to the pointer slot itself, by letting its contents be overwritten atomically by each update. During layout change barriers, this pad may be dissolved, and new ones may be created in other slots. But during epochs, while an object is live, a pointer slot is always occupied by one pad fixedly. For precisely this reason, the pad sampling in an epoch need no longer be carried out atomically. The pad is read-only during the epoch and can be read incrementally, if so wished.

Thus deferred frees are no longer needed to support pointer updates. However, for object de-allocation, a deferred free has to be used, since other threads may be holding on to the pad to read it. Only a deferred free guarantees that such threads are done before the de-allocation occurs.

An attempt to leverage large writes for reference counting pads runs into complexity again. At least an atomic read-modify-write instruction on the count is needed on the count field, that runs in concurrence with the atomic reads/writes of the block to handle reference counting with minimum synchronization. Since a shared pad can evolve in two different slots differently, the scheme has to let a pad be overwritten by a new pad in an update so that the preceding shared pad with a 1+reference count in it can be dropped while a new pad is installed in the pointer slot. In this endeavour, however, the dropped pad also has to have its count decremented, which only the winner of the overwrite must do else there may be multiple decrements happening to the dropped pad's count. For this, a lock-based critical section may implement the overwrite, but this is expensive. Otherwise, the reference counting scheme of the preceding section can be given, in which for an object, only thread-local pads are kept, with the reference count maintained by the local thread alone. This scheme, involves deferred frees and may be carried out as discussed before.

Thus unshared pads, with no reference counting may be implemented with great benefit by large atomic block writes, if available in the language/platform.

Wand in Context: Distributed Parallelism or Distributed Shared Memory Machines

One model of programming a parallel, distributed, shared memory machine is defined by Unified Parallel C (UPC). In UPC, a pointer may be a fat pointer comprising a remote processor id and an address within that processor. Such information is very nicely expressible within a one-word standard boxed pointer presented here. In UPC, a memory access on a remote processor may be carried out using a distributed system call, say a remote procedure call or RPC. In the UPC context, the pid is the processor really and heap partitioning is fixed. When writing a pointer to a remote object, there are two options: make the pointer written point back to a pad here, or make it point to a pad created on the remote machine. The former is clearly a bad option (adds a remote access extra to the pointer that's being written). Hence, choosing the latter, then, the writing and remote pad creation is carried out by an RPC to the remote machine. This is clean and simple, since the RPC, if implemented by the remote processor is simply a sequential execution on the remote machine, which can then create the pad locally with very simple memory management as discussed here.

In another scenario, when a remote machine reads a pointer here, it should copy the pad in the same RPC and create it on itself. Now pad circulation everywhere, apriori, does not happen. Pads in a processor are all taken from that processor's memory and a processor when it writes remotely, gets the pads needed from the remote memory. Generalizing UPC to multiple threads per processor, then we have multiple subheaps per processor (one per thread) and within a processor, pads can be circulated among the threads but not across processors. Intra thread non escapee processing will happen as described earlier.

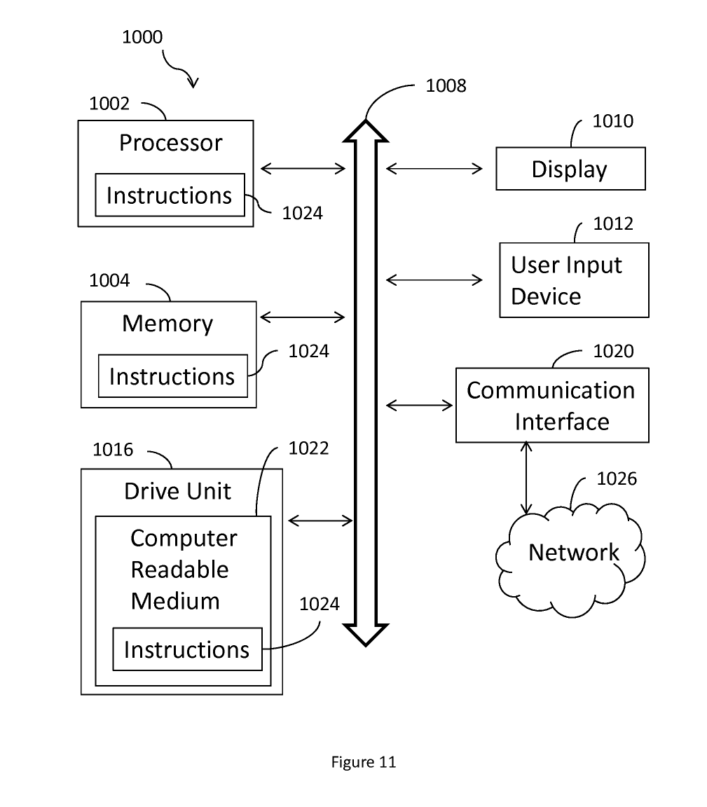

FIG. 11 illustrates a typical hardware configuration of a computer system, which is representative of a hardware environment for practicing the present invention. The computer system 1000 can include a set of instructions that can be executed to cause the computer system 1000 to perform any one or more of the methods disclosed. The computer system 1000 may operate as a standalone device or may be connected, e.g., using a network, to other computer systems or peripheral devices.

In a networked deployment, the computer system 1000 may operate in the capacity of a server or as a client user computer in a server-client user network environment, or as a peer computer system in a peer-to-peer (or distributed) network environment. The computer system 1000 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a control system, a personal trusted device, a web appliance, or any other machine capable of executing a set of instructions (sequential or otherwise) that specify actions to be taken by that machine. Further, while a single computer system 1000 is illustrated, the term “system” shall also be taken to include any collection of systems or sub-systems that individually or jointly execute a set, or multiple sets, of instructions to perform one or more computer functions.

The computer system 1000 may include a processor 1002, e.g., a central processing unit (CPU), a graphics processing unit (GPU), or both. The processor 1002 may be a component in a variety of systems. For example, the processor 1002 may be part of a standard personal computer or a workstation. The processor 1002 may be one or more general processors, digital signal processors, application specific integrated circuits, field programmable gate arrays, servers, networks, digital circuits, analog circuits, combinations thereof, or other now known or later developed devices for analyzing and processing data The processor 1002 may implement a software program, such as code generated manually (i.e., programmed).

The term “module” may be defined to include a plurality of executable modules. As described herein, the modules are defined to include software, hardware or some combination thereof executable by a processor, such as processor 1002. Software modules may include instructions stored in memory, such as memory 1004, or another memory device, that are executable by the processor 1002 or other processor. Hardware modules may include various devices, components, circuits, gates, circuit boards, and the like that are executable, directed, or otherwise controlled for performance by the processor 1002.

The computer system 1000 may include a memory 1004, such as a memory 1004 that can communicate via a bus 1008. The memory 1004 may be a main memory, a static memory, or a dynamic memory. The memory 1004 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one example, the memory 1004 includes a cache or random access memory for the processor 1002. In alternative examples, the memory 1004 is separate from the processor 1002, such as a cache memory of a processor, the system memory, or other memory. The memory 1004 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 1004 is operable to store instructions executable by the processor 1002. The functions, acts or tasks illustrated in the figures or described may be performed by the programmed processor 1002 executing the instructions stored in the memory 1004. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 1000 may or may not further include a display unit 1010, such as a liquid crystal display (LCD), an organic light emitting diode (OLED), a flat panel display, a solid state display, a cathode ray tube (CRT), a projector, a printer or other now known or later developed display device for outputting determined information. The display 1010 may act as an interface for the user to see the functioning of the processor 1002, or specifically as an interface with the software stored in the memory 1004 or in the drive unit 1016.

Additionally, the computer system 1000 may include an input device 1012 configured to allow a user to interact with any of the components of system 1000. The input device 1012 may be a number pad, a keyboard, or a cursor control device, such as a mouse, or a joystick, touch screen display, remote control or any other device operative to interact with the computer system 1000.

The computer system 1000 may also include a disk or optical drive unit 1016. The disk drive unit 1016 may include a computer-readable medium 1022 in which one or more sets of instructions 1024, e.g. software, can be embedded. Further, the instructions 1024 may embody one or more of the methods or logic as described. In a particular example, the instructions 1024 may reside completely, or at least partially, within the memory 1004 or within the processor 1002 during execution by the computer system 1000. The memory 1004 and the processor 1002 also may include computer-readable media as discussed above.

The present invention contemplates a computer-readable medium that includes instructions 1024 or receives and executes instructions 1024 responsive to a propagated signal so that a device connected to a network 1026 can communicate voice, video, audio, images or any other data over the network 1026. Further, the instructions 1024 may be transmitted or received over the network 1026 via a communication port or interface 1020 or using a bus 1008. The communication port or interface 1020 may be a part of the processor 1002 or may be a separate component. The communication port 1020 may be created in software or may be a physical connection in hardware. The communication port 1020 may be configured to connect with a network 1026, external media, the display 1010, or any other components in system 1000, or combinations thereof. The connection with the network 1026 may be a physical connection, such as a wired Ethernet connection or may be established wirelessly as discussed later. Likewise, the additional connections with other components of the system 1000 may be physical connections or may be established wirelessly. The network 1026 may alternatively be directly connected to the bus 1008.

The network 1026 may include wired networks, wireless networks, Ethernet AVB networks, or combinations thereof. The wireless network may be a cellular telephone network, an 802.11, 802.16, 802.20, 802.1Q or WiMax network. Further, the network 1026 may be a public network, such as the Internet, a private network, such as an intranet, or combinations thereof, and may utilize a variety of networking protocols now available or later developed including, but not limited to TCP/IP based networking protocols.

While the computer-readable medium is shown to be a single medium, the term “computer-readable medium” may include a single medium or multiple media, such as a centralized or distributed database, and associated caches and servers that store one or more sets of instructions. The term “computer-readable medium” may also include any medium that is capable of storing, encoding or carrying a set of instructions for execution by a processor or that cause a computer system to perform any one or more of the methods or operations disclosed. The “computer-readable medium” may be non-transitory, and may be tangible.

In an example, the computer-readable medium can include a solid-state memory such as a memory card or other package that houses one or more nonvolatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative example, dedicated hardware implementations, such as application specific integrated circuits, programmable logic arrays and other hardware devices, can be constructed to implement various parts of the system 1000.

Applications that may include the systems can broadly include a variety of electronic and computer systems. One or more examples described may implement functions using two or more specific interconnected hardware modules or devices with related control and data signals that can be communicated between and through the modules, or as portions of an application-specific integrated circuit. Accordingly, the present system encompasses software, firmware, and hardware implementations.

The system described may be implemented by software programs executable by a computer system. Further, in a non-limited example, implementations can include distributed processing, component/object distributed processing, and parallel processing. Alternatively, virtual computer system processing can be constructed to implement various parts of the system.

The system is not limited to operation with any particular standards and protocols. For example, standards for Internet and other packet switched network transmission (e.g., TCP/IP, UDP/IP, HTML, HTTP) may be used. Such standards are periodically superseded by faster or more efficient equivalents having essentially the same functions. Accordingly, replacement standards and protocols having the same or similar functions as those disclosed are considered equivalents thereof.

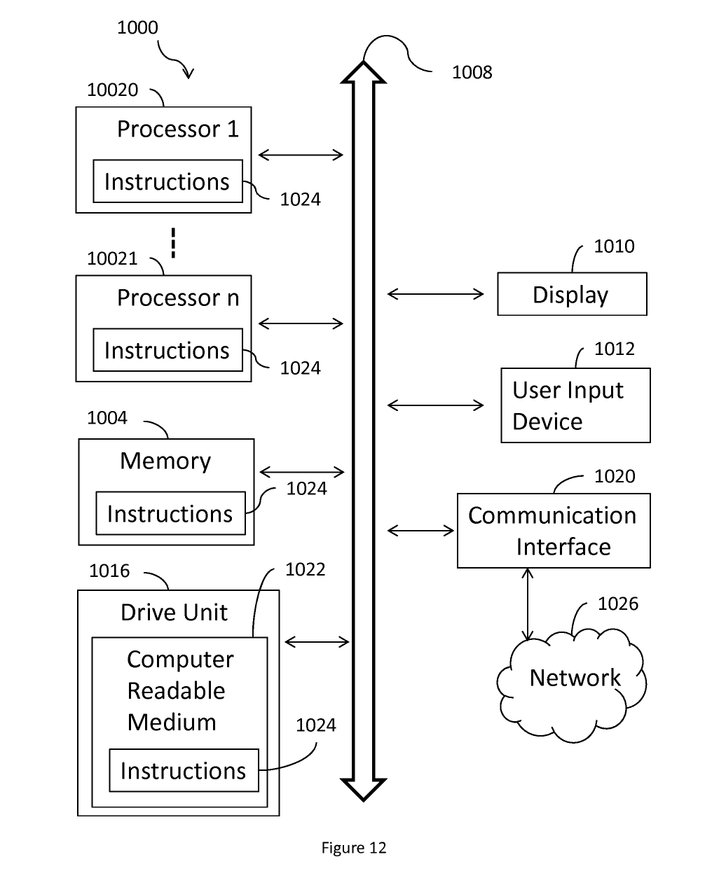

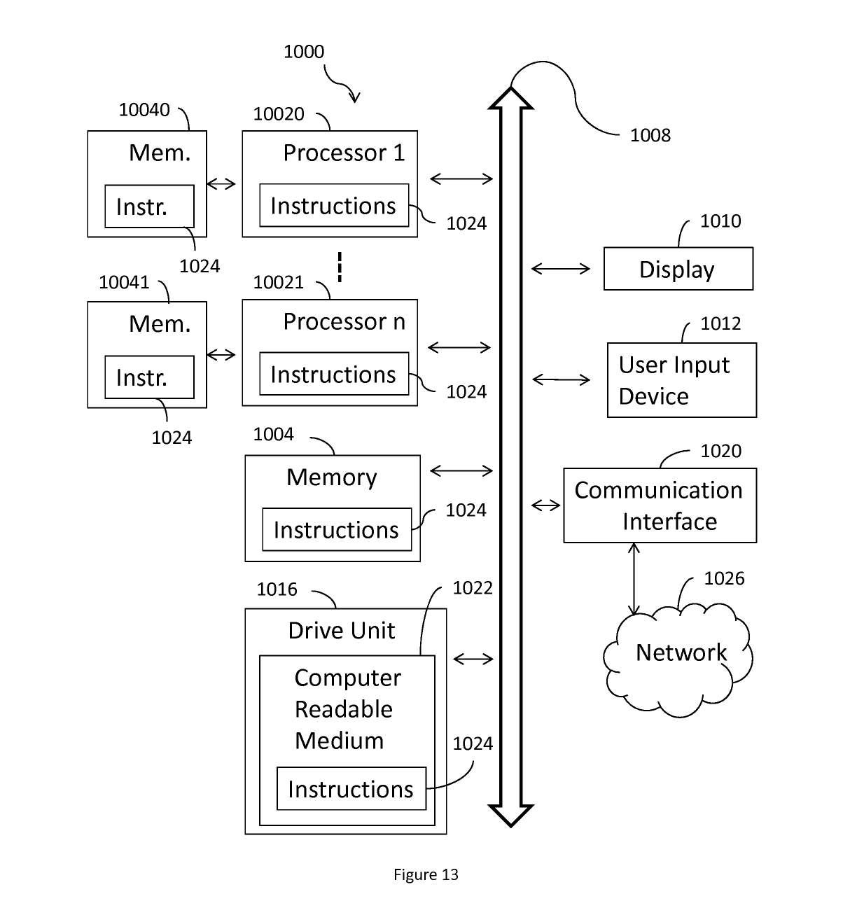

FIG. 12 illustrates a typical hardware configuration of a shared memory parallel computer system, in which the invention may be practiced. FIG. 13, similarly illustrates a typical hardware configuration of a distributed memory parallel computer system, in which the invention may be practiced. In FIG. 12, a plurality of n processors ranging from 10020 to 10021 are used. All the other elements of the figure are shared by the processors, such as the memory 1004, which is shared memory accessed by the processors. In FIG. 13, the shared memory unit 1004 is optional. The processors in FIG. 13 have dedicated private memory units numbered similar to the processors, e.g. memory 10040 for processor 10020. The numbering of units in FIGS. 11-13 overlaps so that the description of a unit for FIG. 11 above applies to its counterpart in a later figure. The description of a processor 1002 in FIG. 11 applies to the processors 10020-10021 of FIGS. 12 and 13. The description of memory 1004 in FIG. 11 applies to the shared (1004) or private memories (10040-10041) of FIGS. 12 and 13, as applicable.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature.

While specific language has been used to describe the disclosure, any limitations arising on account of the same are not intended. As would be apparent to a person in the art, various working modifications may be made to the process in order to implement the inventive concept as taught herein.

What is claimed is:

1. A boxing system for any pointer in a program such that a pointer box accessed by one or more threads or processes can be recycled with no intervening garbage collection.

2. The box of claim 1 such that a new or unique box is used for each non-NULL pointer stored in a variable or location.

3. The unique box of claim 2 such that it is obtained by a sequence of box-reusing, content overwrites of a new box used for the variable or location.

4. The system of claim 1, comprising an object layout or type means for identifying a pointer containing variable or location.

5. The system of claim 1, comprising a means for identifying stack and register allocated pointers by re-using an allocated box collection.

6. The system of claim 5, comprising a precise garbage collector, using the identified stack and register pointers as a part of a root set.

7. The precise garbage collector of claim 6, reclaiming unfreed dead boxes, arising from racing pointer overwrites.

8. The system of claim 1, comprising a box freeing means of explicitly killing a box for freeing using an immediate free or a deferred free.

9. The system of claim 8, comprising a means for reconciling concurrent kills of a box into one kill or free of the box.

10. The system of claim 1, comprising a means of allocating or de-allocating boxes in bulk for sequential or concurrent use.

11. The system of claim 1, comprising a means for creating or destroying a box branchlessly, the means comprising allocation, initialization, or de-allocation, or the use of multiword reads and writes.

12. The system of claim 1, comprising a source-to-source transformation means for complete implementation, with enhanced portability and integrated performance as a result.

13. The system of claim 1, consisting of atomic registers or sequential registers as the sole shared memory or sequential memory primitive, ruling out any synchronization primitives.

14. A parallel, safe, memory management system comprising a heap partitioned among threads, boxed pointers, and deferred frees for providing safe manual memory management integrated with an optional precise garbage collector.

15. The system of claim 14, consisting of atomic registers or sequential registers as the sole shared memory or sequential memory primitive, ruling out any synchronization primitives.

16. The system of claim 14, that collects in parallel, with each thread collecting its own heap partition, clearing marking work sent to the thread on bounded buffers instantly using a deferred tag, thereby keeping all buffers readily available to work producers so that garbage collection progresses monotonically without deadlock, the handling of all such work transpiring in constant space by the reuse of object meta-data structures effectively.

17. The system of claim 16, wherein completion consensus for works like marking transpires by baton passing among threads.

18. The system of claim 14, supporting atomic pointer operations comprising pointer creation or pointer deletion including any needed malloc or free.

19. The system of claim 14, comprising pointer boxes that are unshared, or shared with reference counting, or shared with an implicit infinite count.

20. The system of claim 14, comprising a barrier prior to which accesses to all objects must complete, the barrier purpose comprising deferred freeing of objects or boxes, carrying out of garbage collection, modifying object layouts, creation of threads, or deletion of threads, the barrier itself being implementable using atomic registers only.

21. The system of claim 14, automatically translating a read or write operation on an object by encoding or decoding pointers transferred by the operation, according to the layout of the object.

22. The system of claim 21, using the read-only property of a layout between epochs to be able to carry out reads and writes of scalars in an object atomically, despite the layout and the object occupying and being accessed from separate storages.

23. A parallel, work completion consensus system comprising a means for passing a baton round robin among threads till a complete round is made in which no fresh work is recorded by any thread in the baton.

24. The system of claim 23, consisting of atomic registers or sequential registers as the sole shared memory or sequential memory primitive, ruling out any synchronization primitives.

25. A tagged union system comprising an object layout or type means for identifying a union containing variable or location, and a boxed means for implementing the union that substitutes the union with a pointer to a box wherein the box specifies the tag of the union and its contents, the contents thereby getting a fully unconstrained storage, despite being placed in a union that occupies the same space as the contents.

26. A parallel garbage collection system, that collects in parallel, with each thread collecting its own heap partition, clearing marking work sent to the thread on bounded buffers instantly using a deferred tag, thereby keeping all buffers readily available to work producers so that garbage collection progresses monotonically without deadlock, with completion consensus for works like marking transpiring by baton passing among threads.

27. The system of claim 26, consisting of atomic registers or sequential registers as the sole shared memory or sequential memory primitive, ruling out any synchronization primitives.

28. A parallel deferred freeing system comprising a barrier means using which all threads free cached objects in parallel and completion consensus is arrived at by baton passing.

29. The system of claim 28, freeing pointer boxes in an object while freeing the object, the non-local boxes being collected in constant space by re-using object metadata of the boxes effectively.

30. The system of claim 28, consisting of atomic registers or sequential registers as the sole shared memory or sequential memory primitive, ruling out any synchronization primitives.

31. A boxing method for any pointer in a program such that a pointer box accessed by one or more threads or processes can be recycled with no intervening garbage collection.

32. A parallel, safe, memory management method for providing safe manual memory management operations integrated with an optional precise garbage collector, comprising the steps of partitioning heap among threads, boxing pointers, and deferred freeing.

33. A parallel, work completion consensus method comprising a step for passing a baton round robin among threads till a complete round is made in which no fresh work is recorded by any thread in the baton.

34. A tagged union method comprising an object layout or type step for identifying a union containing variable or location, and a boxing step for implementing the union by substituting the union with a pointer to a box wherein the box specifies the tag of the union and its contents, the contents thereby getting a fully unconstrained storage, despite being placed in a union that occupies the same space as the contents.

35. A parallel garbage collection method, that collects in parallel, with each thread collecting its own heap partition, clearing marking work sent to the thread on bounded buffers instantly using a deferred tag, thereby keeping all buffers readily available to work producers so that garbage collection progresses monotonically without deadlock, with completion consensus for works like marking transpiring by baton passing among threads.

36. A parallel deferred freeing method comprising a barrier step using which all threads free cached objects in parallel and completion consensus is arrived at by baton passing.
